(19) United States
(12) Patent Application Publication
(10) Pub. No.: US 2012/0036444 A1
(43) Pub. Date: Feb. 9, 2012

(54) Systems and Methods for Interactive Web-based Social Networking and Activities Coordination

(76) Inventor: Ann-Cabell Baum ANDERSEN, Raleigh, NC (US)

(21) Appl. No.: 13/174,989

(22) Filed: Jul. 1, 2011

Related U.S. Application Data
(60) Provisional application No. 61/360,572, filed on Jul. 1, 2010.
(60) Provisional application No. 61/372,285, filed on Aug. 10, 2010.

(51) Int. Cl. G06F 3/01

(52) U.S. Cl. 715/738

(57) ABSTRACT

Automated, user-centric, interactive web-based social networking systems and methods for at least two groups of users, including customer users, which are individuals, and service provider users, which are associated with restaurants, businesses, and/or service provider individuals; also automated appointment event notification matching or corresponding to user-indicated interests that are customized by a first customer user(s) within predetermined geographies and/or subgeographies, wherein the customization, configuration and operation of the systems and methods are driven by a user-centric perspective and factors therefor.

### CROSS-REFERENCE TO RELATED APPLICATIONS

The present invention is related to one or more prior-filed co-pending patent applications and claims priority therefrom; it claims the benefit from U.S. Provisional Patent Application Ser. No. 61/360,572, filed Jul. 1, 2010 and U.S. Provisional Patent Application Ser. No. 61/372,285, filed on Aug. 10, 2010, which are both incorporated herein by reference in their entirety.

### BACKGROUND OF THE INVENTION

1. Field of the Invention

The present invention relates to virtual social networking, and more particularly, to interactive web-based social networking systems and methods therefor.

2. Description of the Prior Art

It is generally known in the prior art to provide social networking systems that provide a match based on compatibility of user interests. Social networking systems based on user-generated lists of interests and goals where the contents of the list are prioritized or ranked are also known.

By way of example: U.S. Pat. No. 7,451,161; US Pub. Nos. 2006/0247940 & 2009/0024548 for Compatibility scoring of users in social networking, assigned to Friendster, Inc., describes a method of quantifying compatibility of interests or similarity in interests between members of a social network and providing a match based on the compatible interests. A set of individuals who are within a predetermined degree of separation from a first individual are taken and a compatibility score is computed between the first individual and each of the individuals in the set. Compatibility of the individuals is scored based on compatibility of interests, and these compatibility results and compatibility scores are presented to the individuals. Compatibility scores are linked to interest profiles, encouraging people to enter interests so the site can find other people who share the same or compatible interests.

U.S. Pat. No. 7,502,748 for Job matching system and method, assigned to Careerious Inc., describes a job matching system and method that utilizes personality profiles and candidate interests to match candidates to jobs. Employment position data is received from potential employers and individual candidate data is received from job candidates. The candidate data is compared with the employment position data to create a list of employment positions that match the candidate data. A score indicative of a candidates' suitability for a given employment opportunity is calculated from the comparison of the employment position data and individual candidate data

U.S. Pat. No. 7,617,160 for Choice-based relationship system (CRS), assigned to Grove, describes a system to connect event participants with other event participants having similar interests. The event may be a business conference, a cruise, a social gathering, or a virtual event. Profiles are created for the participants indicating preferences and characteristics of the participants. In response to an inquiry from a participant, profiles are compared and matches to other participants with similar interests are generated. This system allows the participants to connect with each other before, during, and after the event.

US Pub. No. 2008/0288494 for System enabling social networking through user-generated lists, describes a social networking method using user generated lists. A list database is generated based on the lists created or populated by users of the system. The list database may also include previously built lists or lists of publications, organizations, or groups. The method includes receiving a first list of items from a first user, receiving a second list of items from a second user. The determination of position of items in a third list includes performing a mathematical computation involving the first value corresponding to a first position of the first item in the first list and the second value corresponding to a second position of the first item in the second list. The third list is then displayed on the computer screen with items in that order. Users can generate a list (e.g., favorite movies) and share the list with others who can then rank the list according to their own preferences. Users can also search or browse lists created by others.

US Pub. No. 2009/0187829 for aggregation and visualization of reused shared lists, describes a shared list social networking system and provides for aggregating and visualizing reused shared lists. An example of a shared list is a rank-ordered list of likes or dislikes. Describes that users can select an existing shared list on a topic, view rank-ordered results, create a new shared list on the topic incorporating users individual rank-ordering of the shared list, and save the new shared list in association with the existing shared list. An aggregation view displays items for each rank or lists items in rank order based on the rankings of multiple users.

US Pub. No. 2008/0162431 for identifying interest twins in an online community, describes a method for identifying members in an online community with similar interests to other members of the online community, and determining if the users are “interest twins”. “Interest twins” are members that have demonstrated interest in the same or similar items. Member interests are identified by “interest-actions” such as following a link to a web page, bookmarking a web page, tagging items, playing or downloading videos, etc. Information on “interest twins” is used to enhance the experience of the user, such as ranking or highlighting search results from a search engine based on the interests of a user's “interest twin”. This invention does not appear to describe introductions or personal connections with “interest twins”.

US Pub. No. 2009/0327270 for Using variation in user interest to enhance the search experience describes a method to enhance the search experience by making the results list responsive to the interests of different individuals and groups of users. The system includes a search interface that determines the variability of search interests (e.g., goals) given queries, and a search experience enhancer. The search interface accepts a query from a user as input, and determines a variability in user interest (e.g. in search goals) for the query.

Furthermore, it is generally known to provide calendar, schedule, or time-based systems and methods using computer software and network or cloud-based access, or shared calendaring. The present invention relates to calendar, schedule, and/or time-based systems and methods using computer software for providing network or cloud-based notification for time slot openings or calendar/schedule availability including providing notification system based upon predetermined social network connections to individuals, companies, and service providers of interest to a participant or user. Users of the system can opt-in to the notification system based upon a click-select activation or hyperlink from an interactive graphical user interface (GUI) on a website accessed through a network, such as the internet.

US Publication No. 20080098313 for System and method for developing and managing group social networks describes a system and method for facilitating the configuration and management of events within a social networking system, wherein members of similar or different geographic locations and/or interests, hobbies, social status, relationship status can interact with the system to view activities, register or participate in those activities and schedule activities; further describes a personal workspace that enables the members of the network to view the personal calendar and the scheduled events and activities, and registration.

### SUMMARY OF THE INVENTION

The present invention relates to interactive web-based social networking systems and methods for at least two groups of users, including customer users, which are individuals, and service provider users, which are associated with restaurants, businesses, and/or service provider individuals.

The systems and methods of the present invention also provide for automated appointment event notification matching or corresponding to user-indicated interests that are customized by a first customer user(s) for notifying other customer users associated with and/or approved or pre-approved by the first customer user(s).

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a screenshot of a website interactive user interface of one embodiment of the invention, illustrating a welcome message for at least one remote user to access and interact with the systems and methods of the present invention.

FIG. 2 is a screenshot of a website interactive user interface of one embodiment of the invention, illustrating another aspect of the present invention.

FIG. 3 is a screenshot of a website interactive user interface of one embodiment of the invention, illustrating another aspect of the present invention.

FIG. 4 is a screenshot of a website interactive user interface of one embodiment of the invention, illustrating another aspect of the present invention

FIG. 5 is a screenshot of a website interactive user interface of one embodiment of the invention, illustrating another aspect of the present invention, showing a first highlight event.

FIG. 6 is a screenshot of a website interactive user interface of one embodiment of the invention, illustrating another aspect of the present invention, showing a second highlight event.

FIG. 7 is a screenshot of a website interactive user interface of one embodiment of the invention, illustrating another aspect of the present invention, showing a third highlight event.

FIG. 8 is a screenshot of a website interactive user interface of one embodiment of the invention, illustrating another aspect of the present invention, showing an interactive geographic map.

FIG. 9 is a screenshot of a website interactive user interface of one embodiment of the invention, illustrating another aspect of the present invention, showing an explore page including a pop-up message.

FIG. 10 is a screenshot of a website interactive user interface of one embodiment of the invention, illustrating a listings page.

FIG. 11 is a screenshot of a website interactive user interface of one embodiment of the invention, illustrating an events page.

FIGS. 12-14 are screenshots of a website interactive user interface of an embodiment of the present invention, illustrating other aspects of the event page of FIG. 11.

FIG. 15 is a screenshot of a website interactive user interface of one embodiment of the invention, illustrating the events page and drop-down location selection for interactive customer user selection of a location to be included in her/his customized personal settings and/or preferences and/or specific events and locations to schedule and coordinate with other users.

FIG. 16 is a screenshot of a website interactive user interface of one embodiment of the invention, illustrating an explore arts and entertainment page, including at least one pop-up message.

FIG. 17 is a screenshot of a website interactive user interface of one embodiment of the invention, illustrating an explore dining page.

FIG. 18 is a screenshot of a website interactive user interface of one embodiment of the invention, illustrating an explore travel and lodging page.

FIG. 19 is a screenshot of a website interactive user interface of one embodiment of the invention, illustrating an explore nightlife page.

FIG. 20 is a screenshot of a website interactive user interface of one embodiment of the invention, illustrating an explore professional services page.

FIG. 21 is a screenshot of a website interactive user interface of one embodiment of the invention, illustrating an explore real estate page.

FIG. 22 is a screenshot of a website interactive user interface of one embodiment of the invention, illustrating an explore shopping page.

FIG. 22 is a screenshot of a website interactive user interface of one embodiment of the invention, illustrating another aspect of the present invention, showing a first highlight event.

FIG. 23 is a screenshot of a website interactive user interface of one embodiment of the invention, illustrating another aspect of the present invention, showing a second highlight event.

FIG. 24 is a screenshot of a website interactive user interface of one embodiment of the invention, illustrating another aspect of the present invention, showing a third highlight event.

FIG. 25 is a screenshot of a website interactive user interface of one embodiment of the invention, illustrating another aspect of the present invention, showing an interactive geographic map.

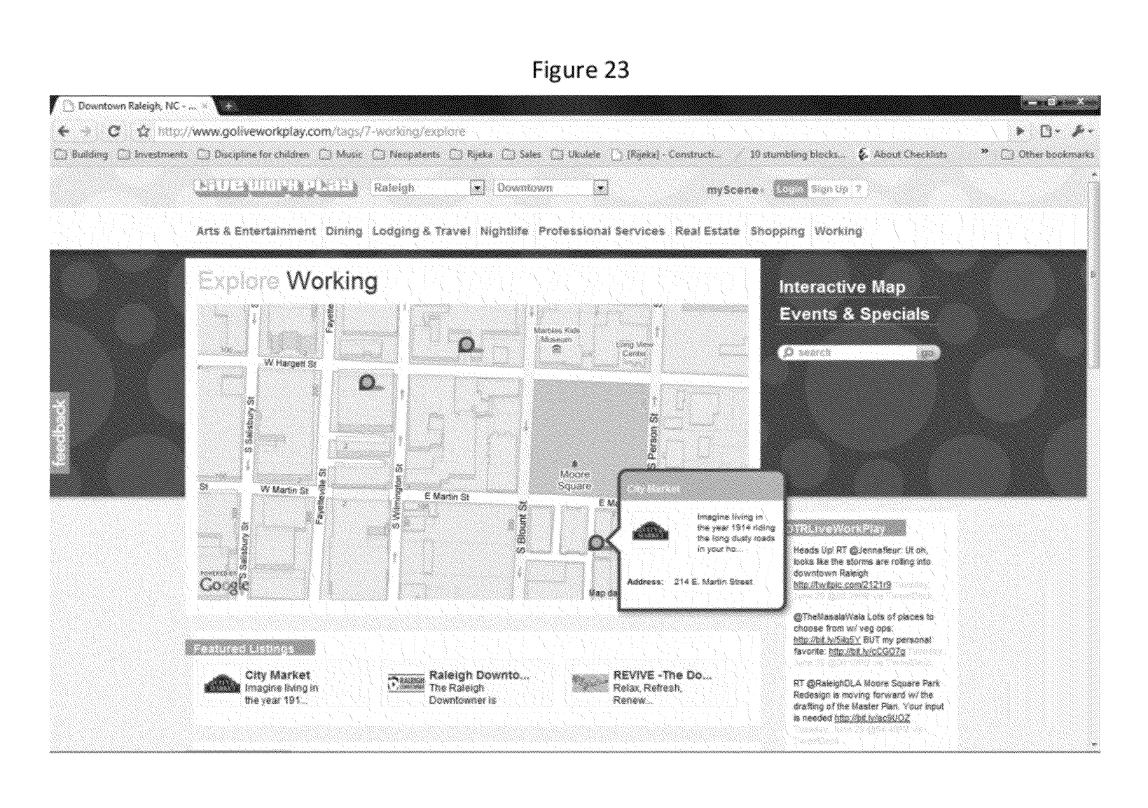

FIG. 23 is a screenshot of a website interactive user interface of one embodiment of the invention, illustrating an explore working page.

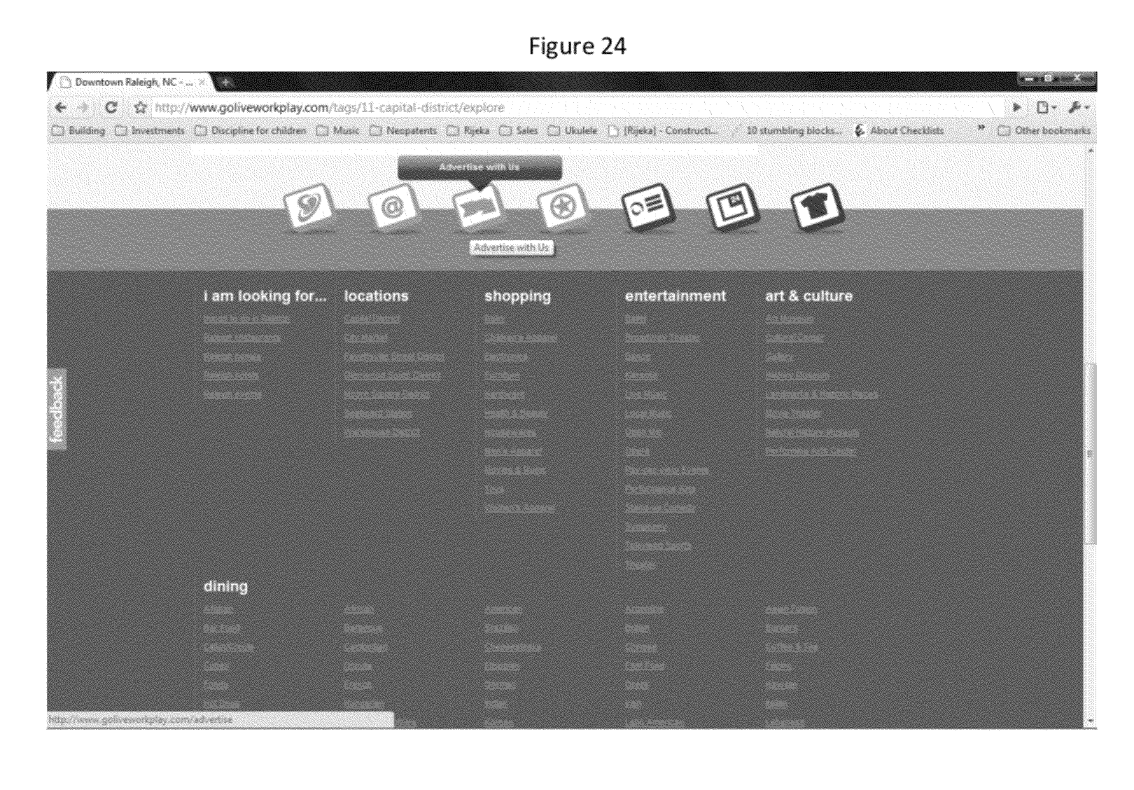

FIG. 24 is a screenshot of a website interactive user interface of one embodiment of the invention, illustrating customer service icons, including pop-up message box.

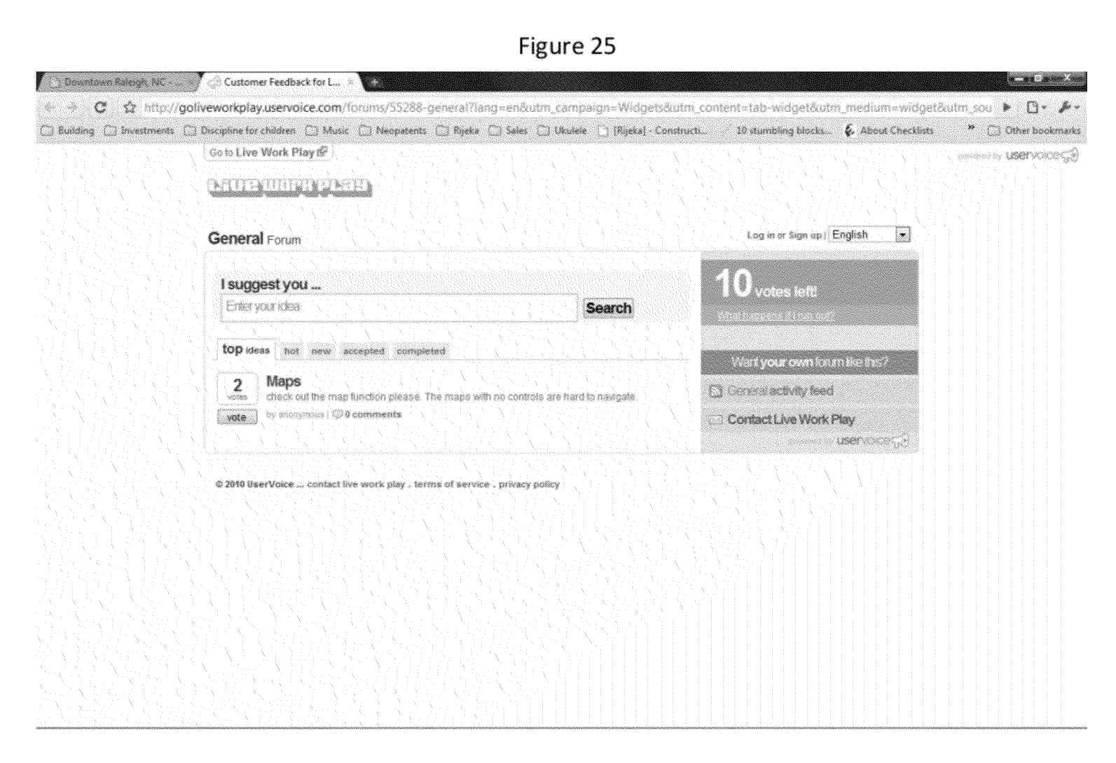

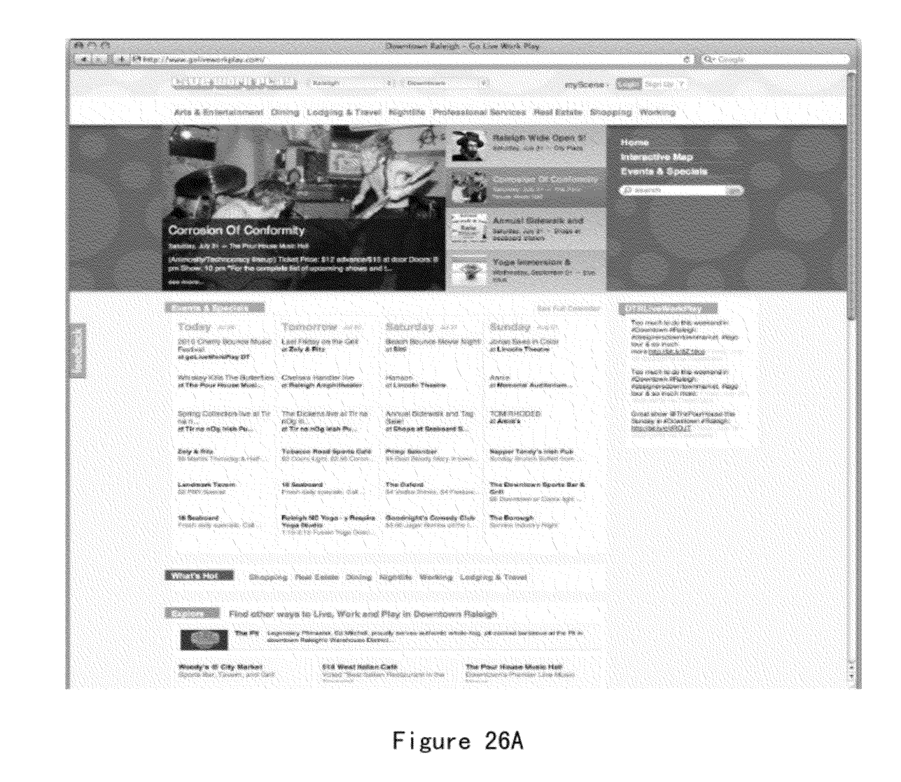

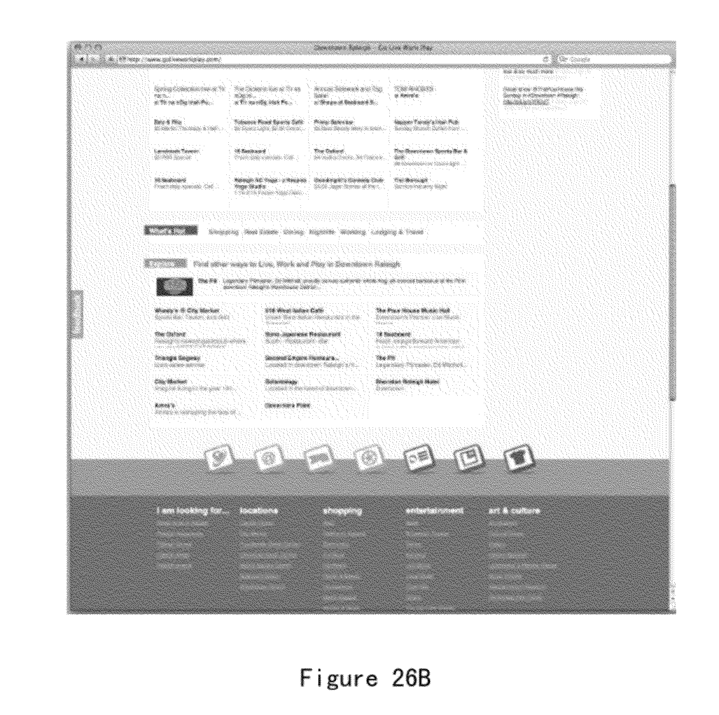

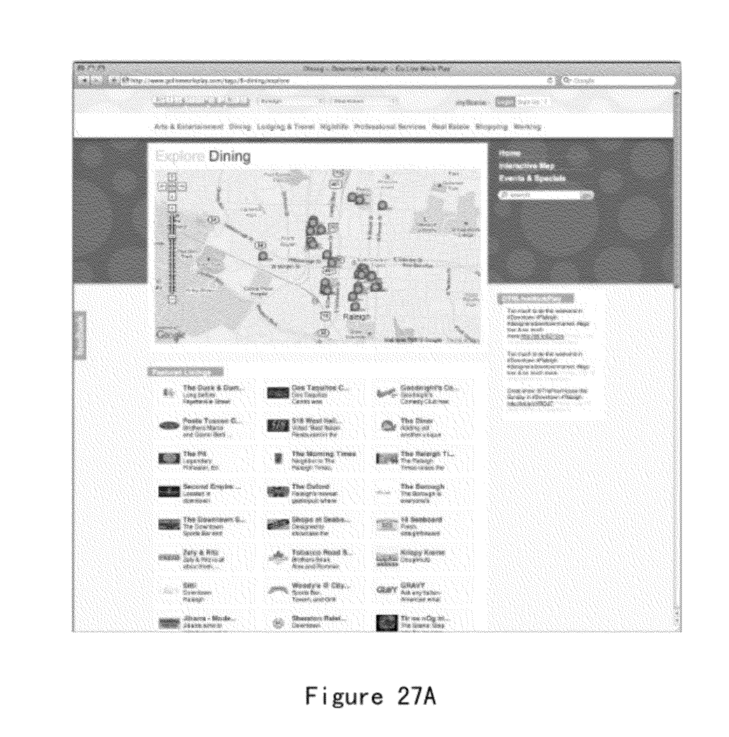

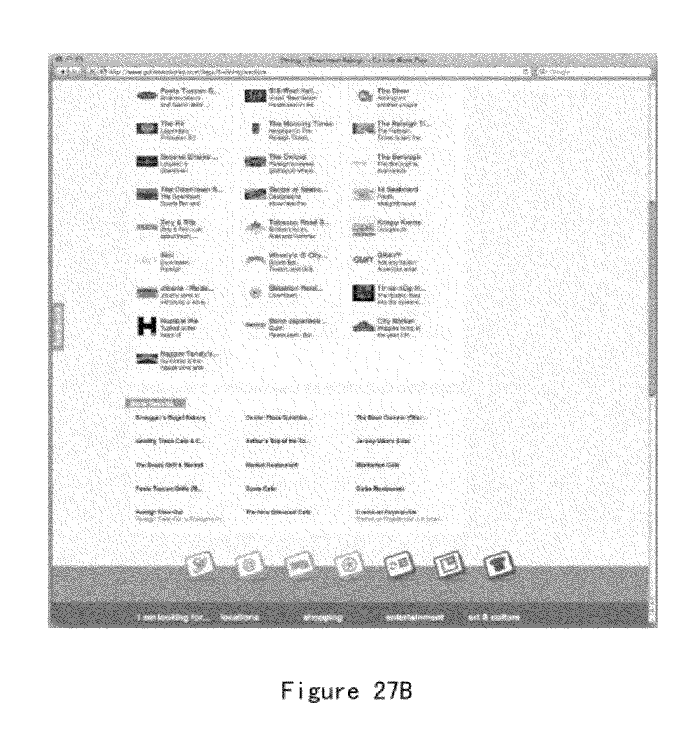

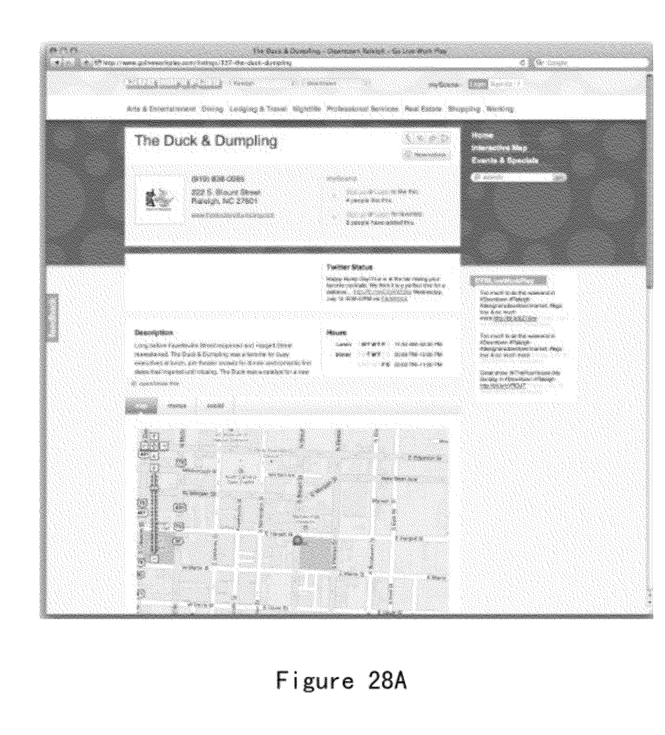

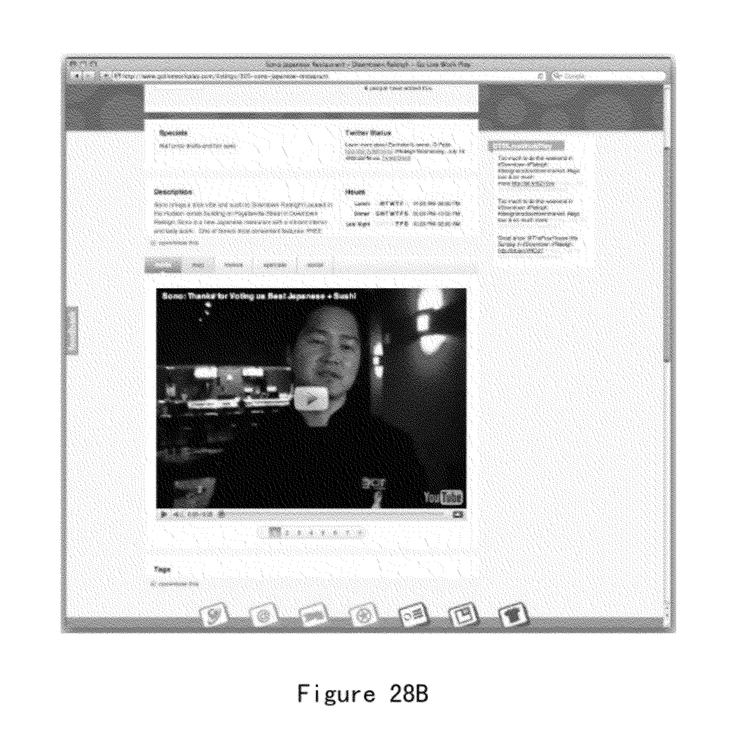

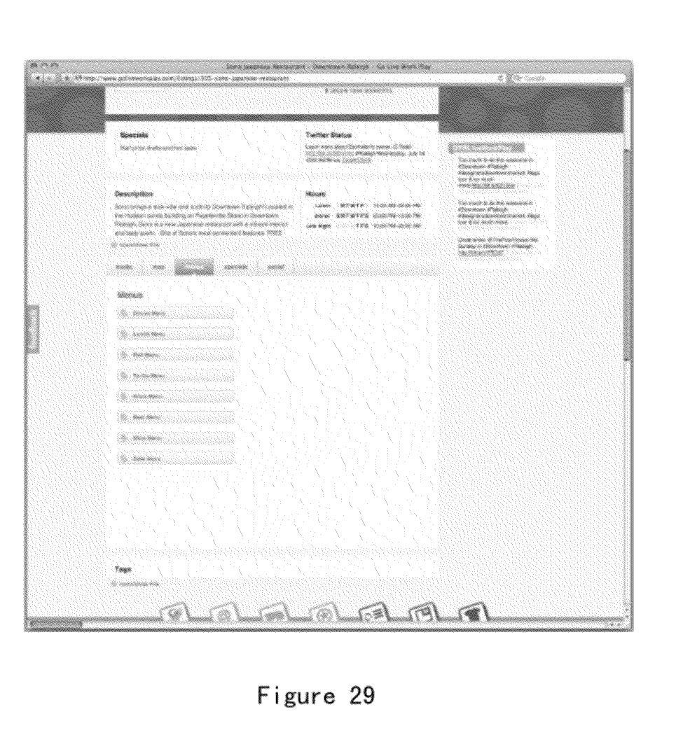

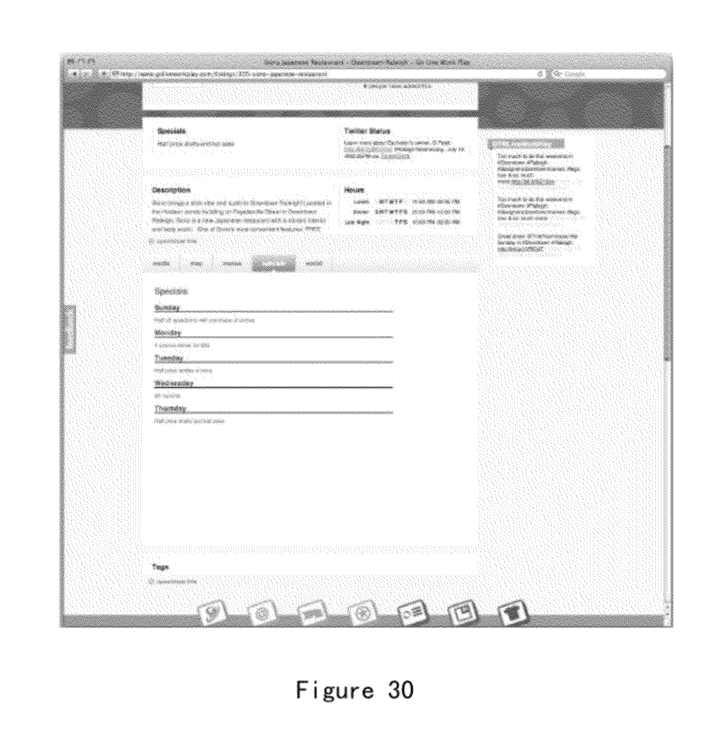

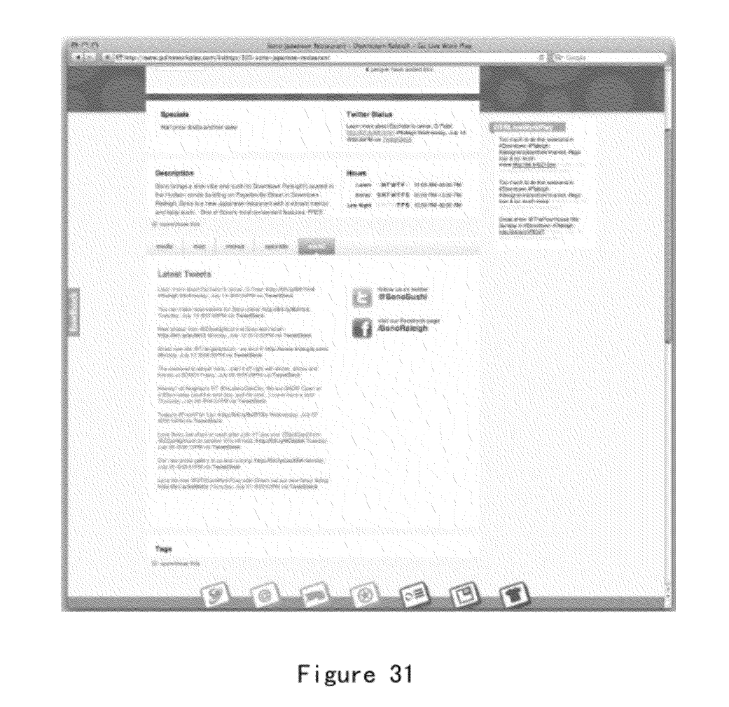

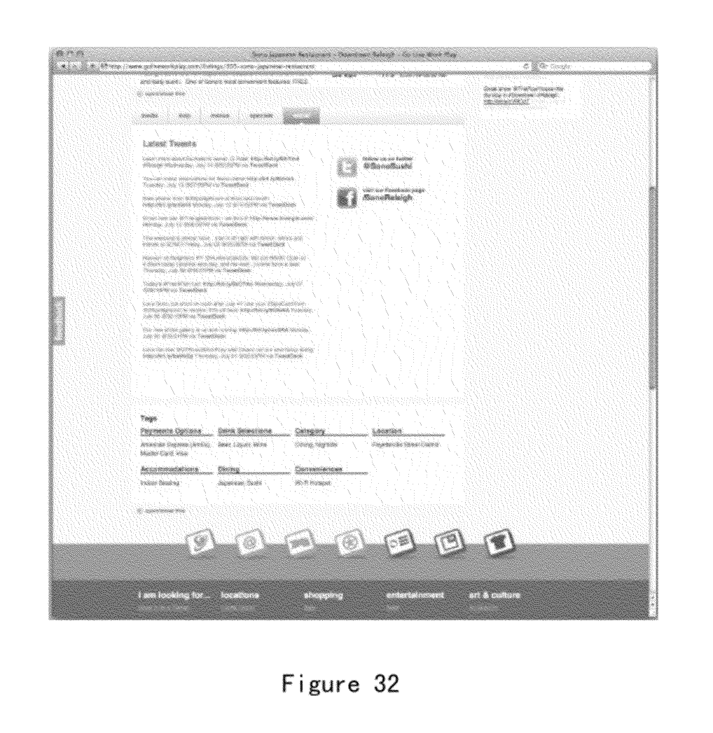

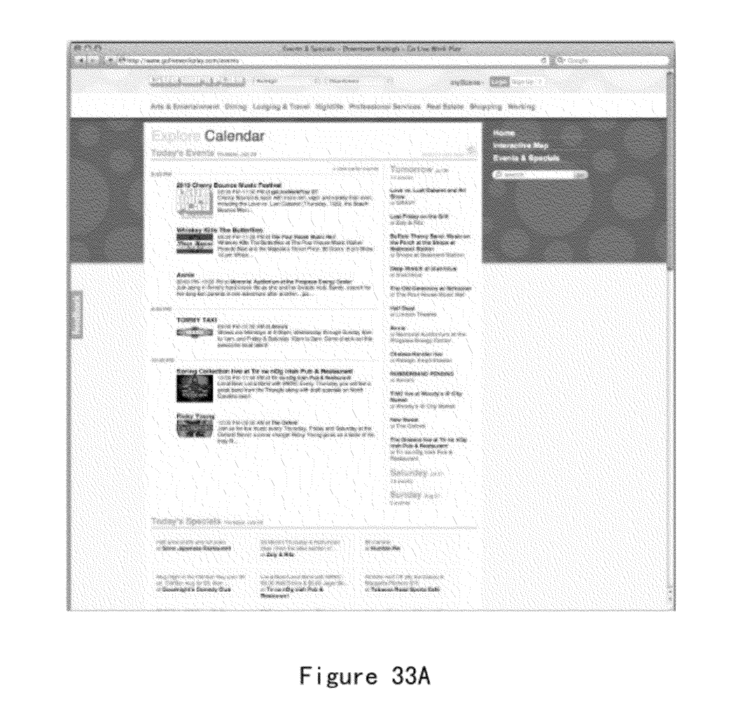

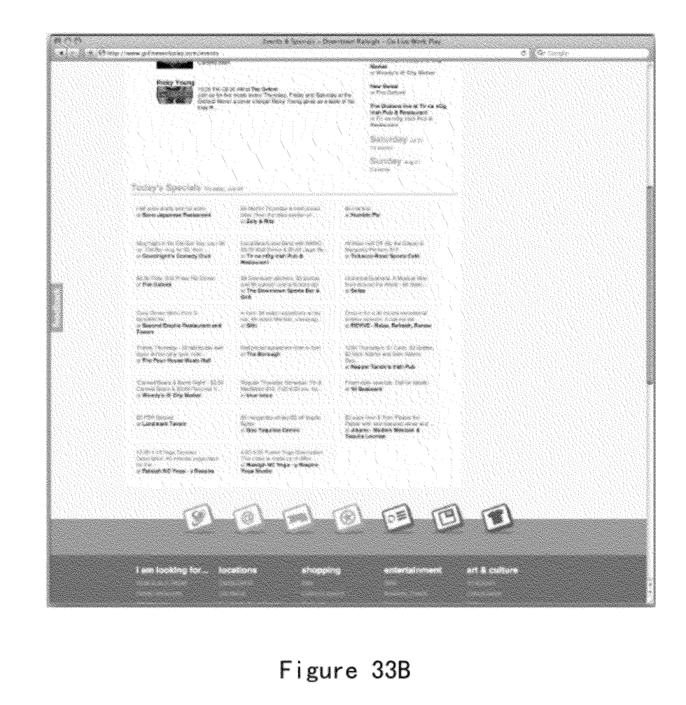

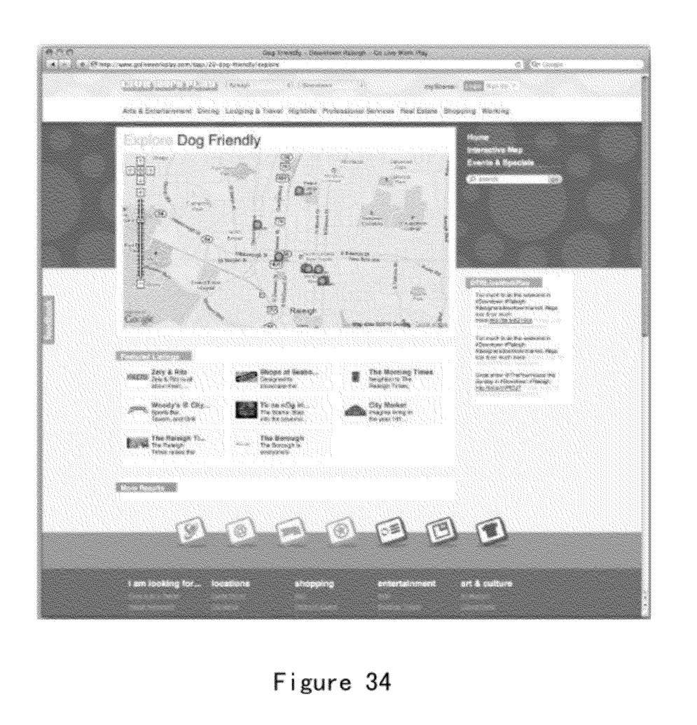

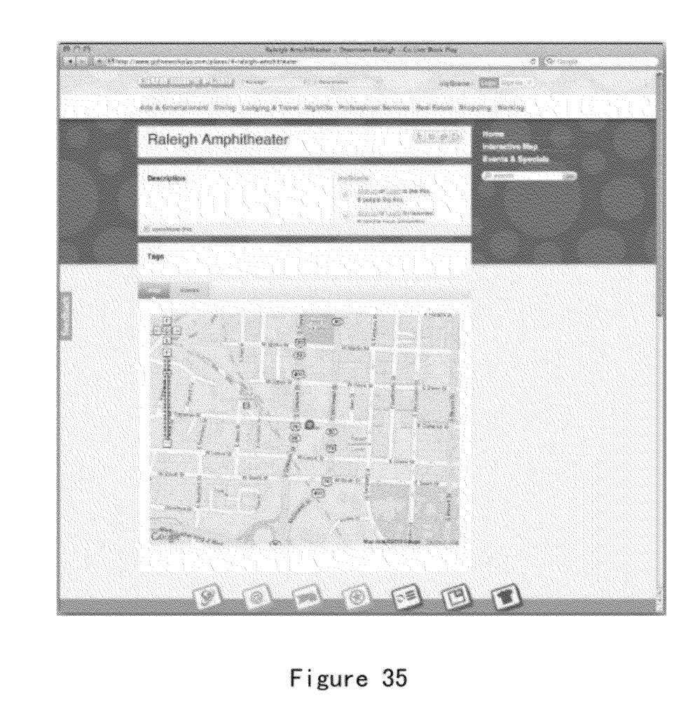

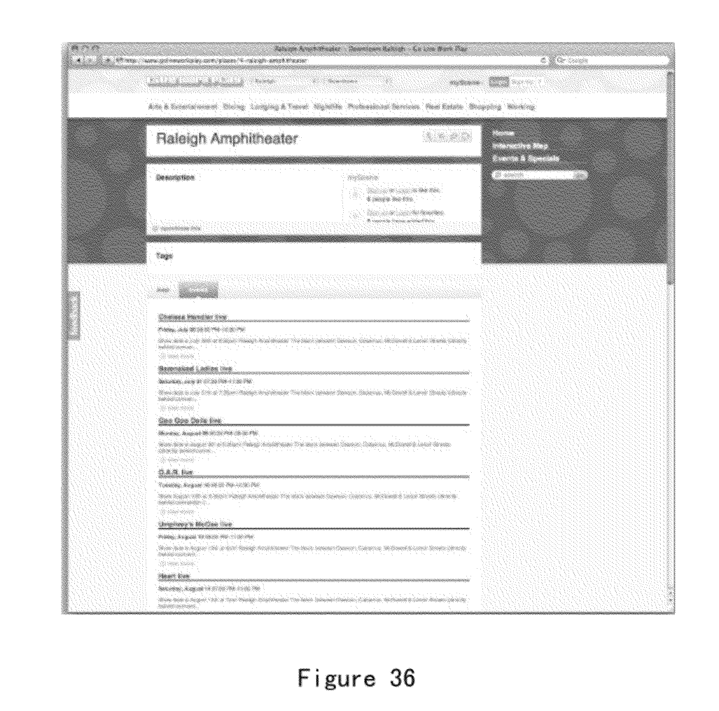

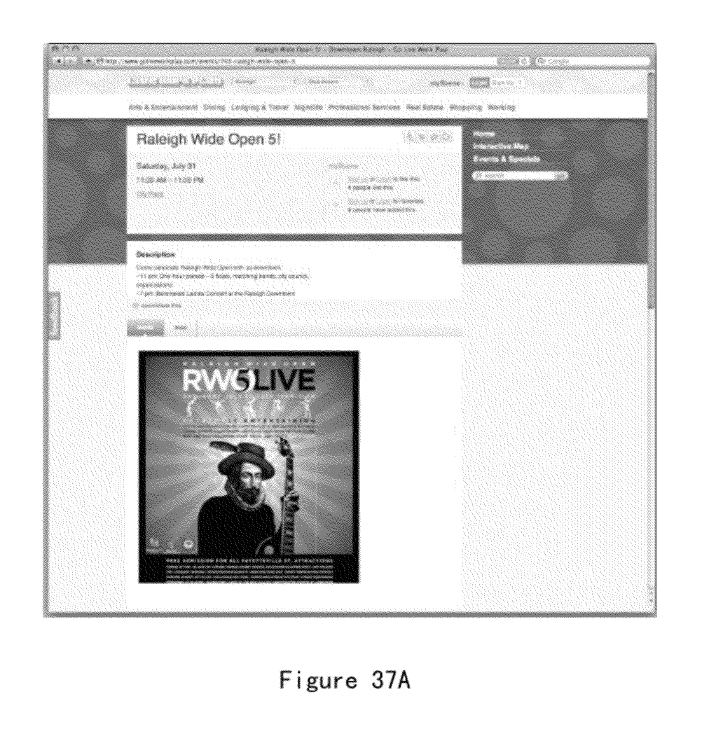

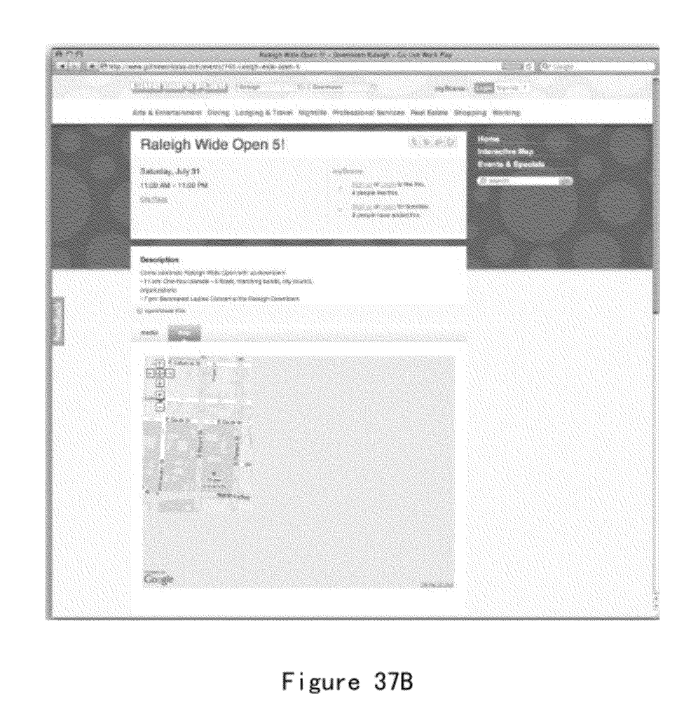

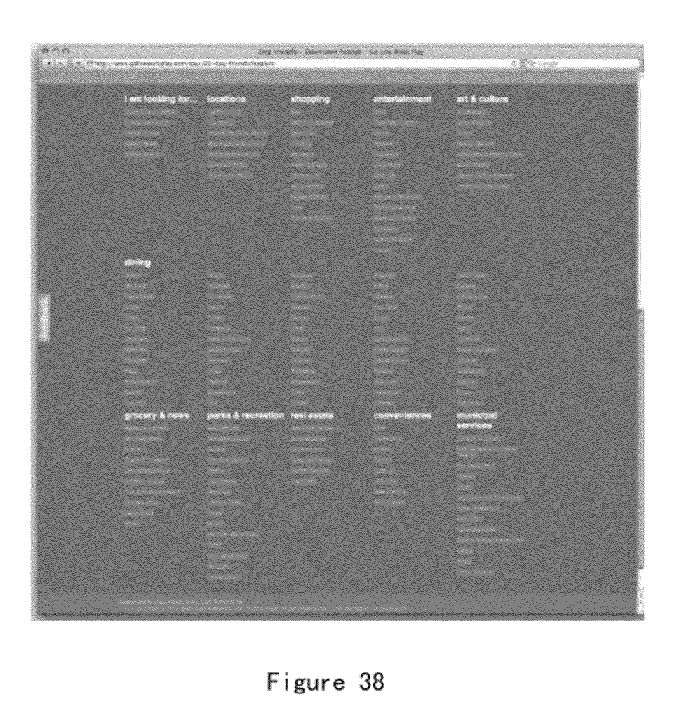

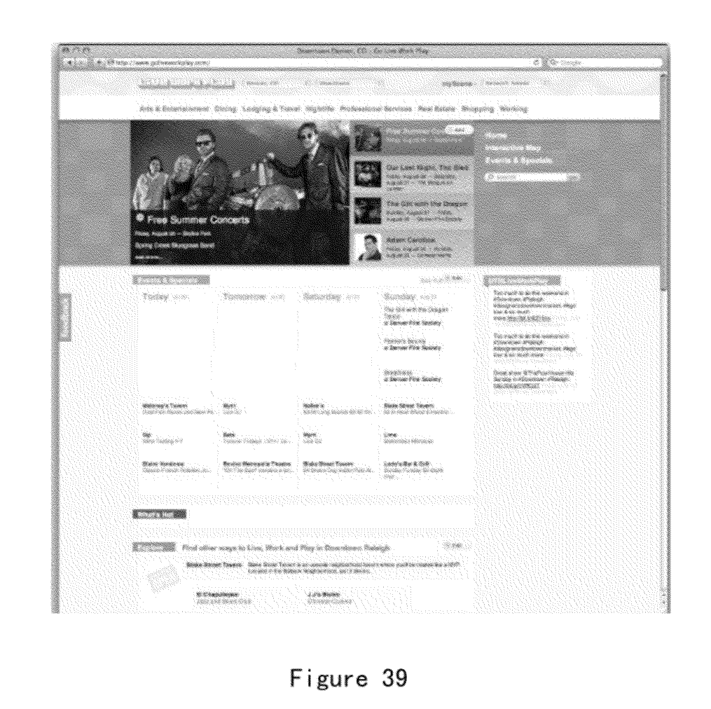

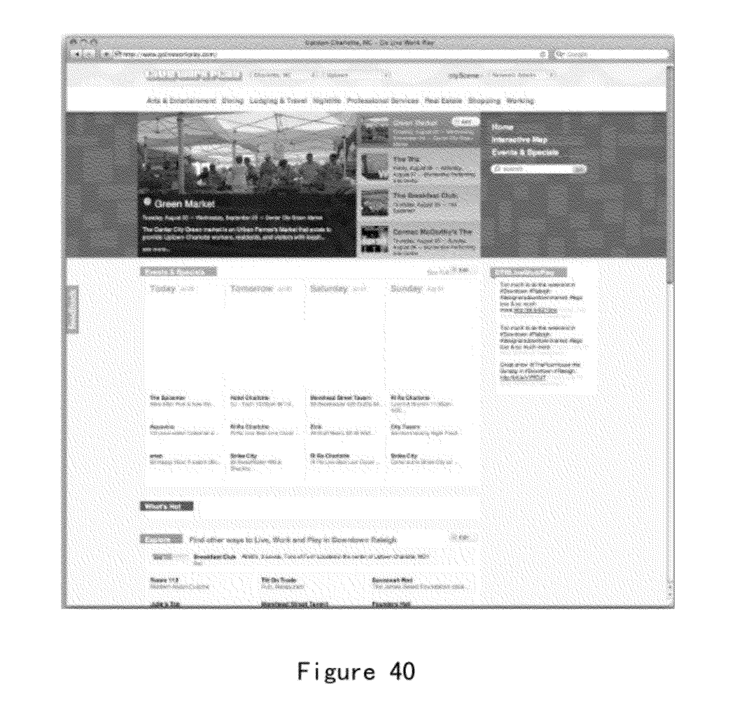

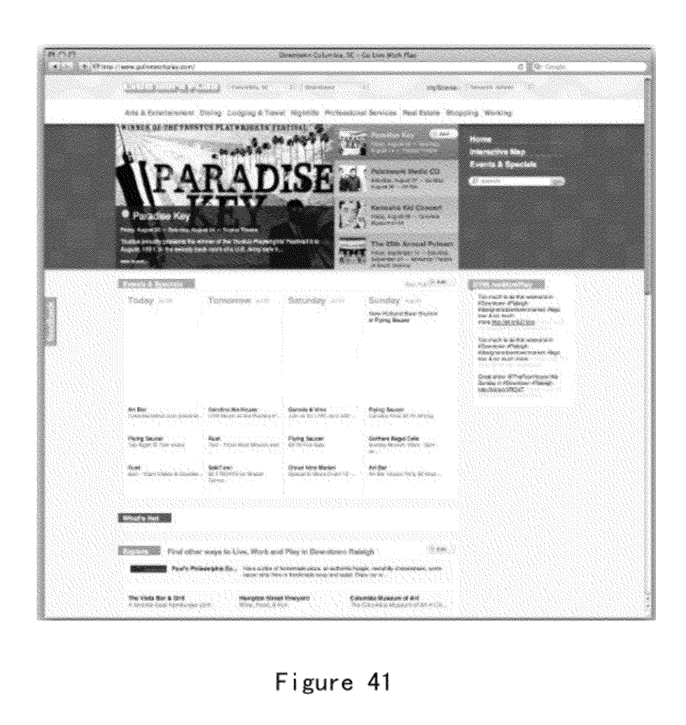

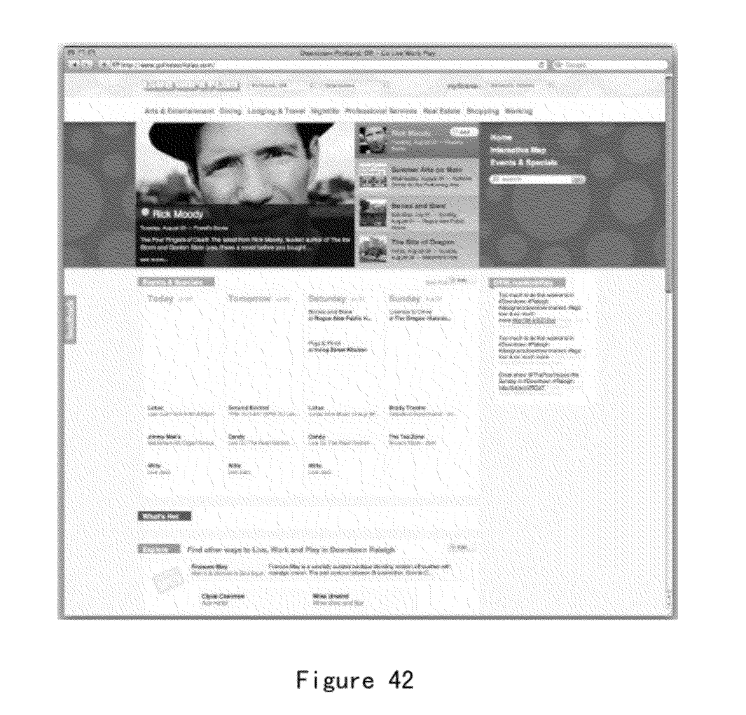

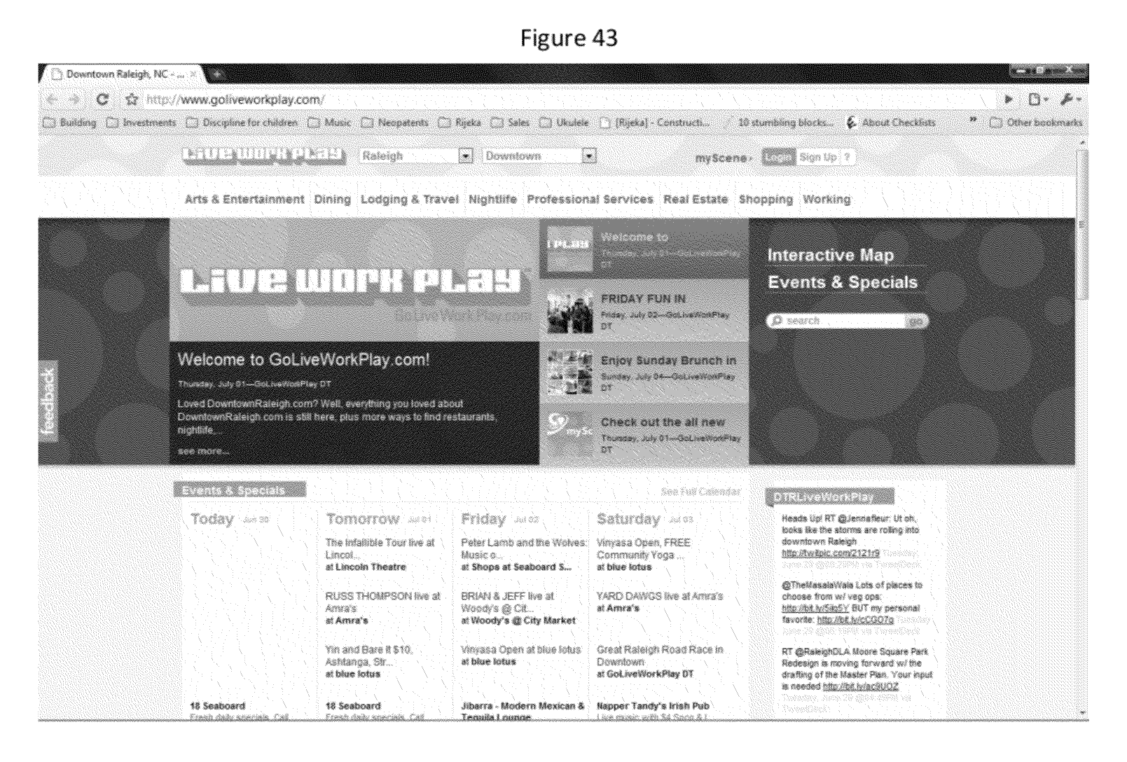

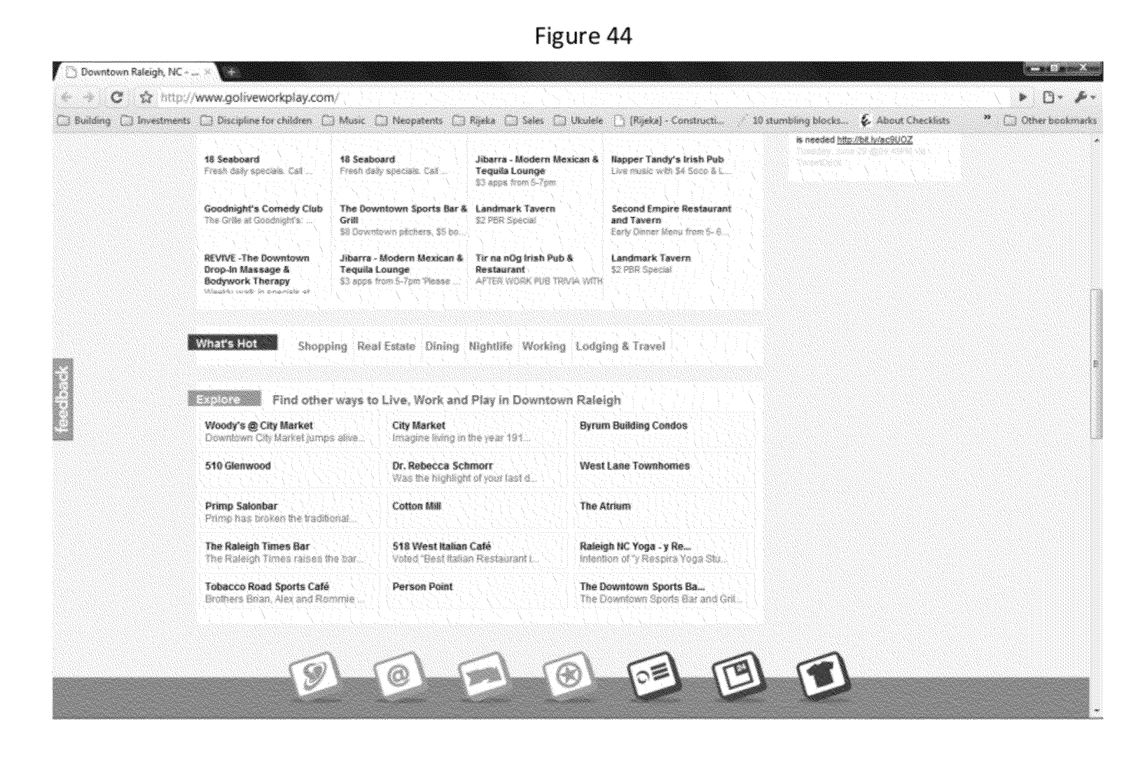

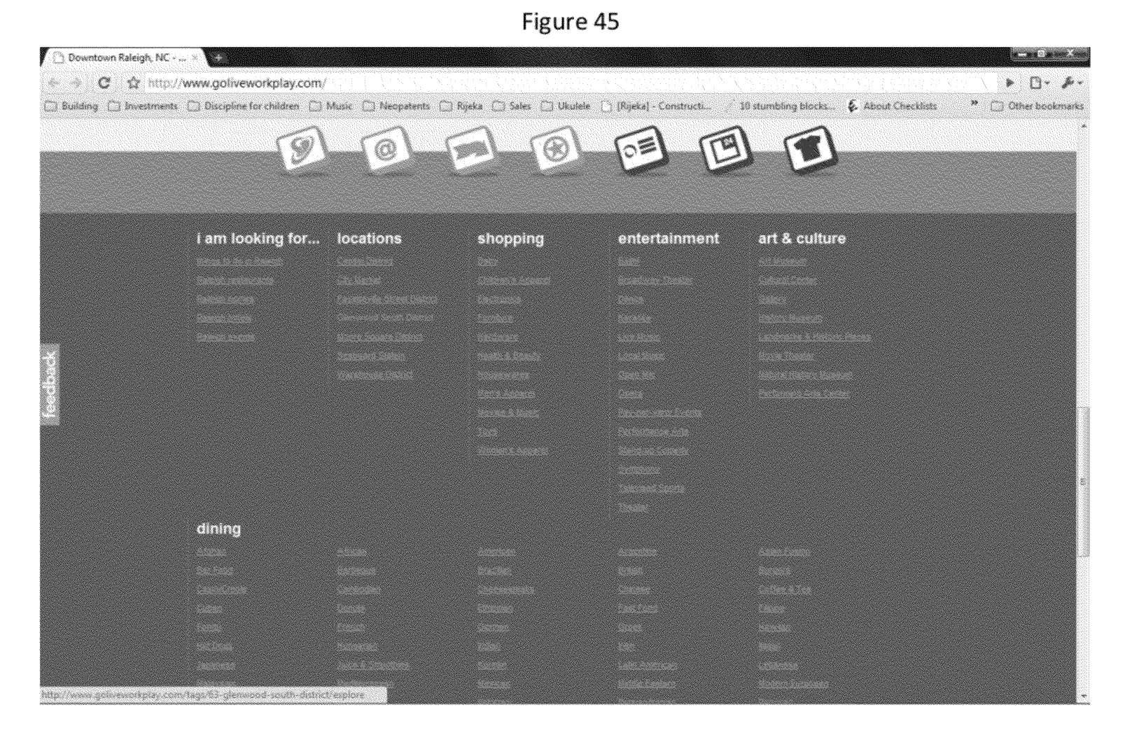

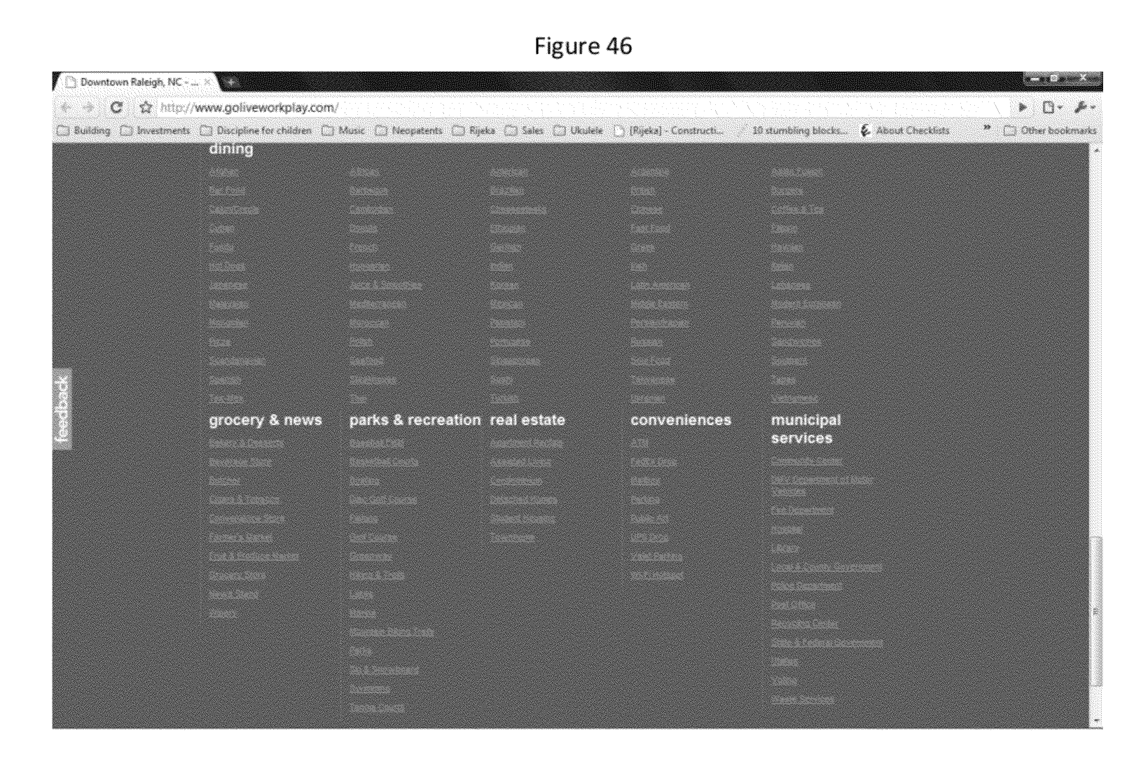

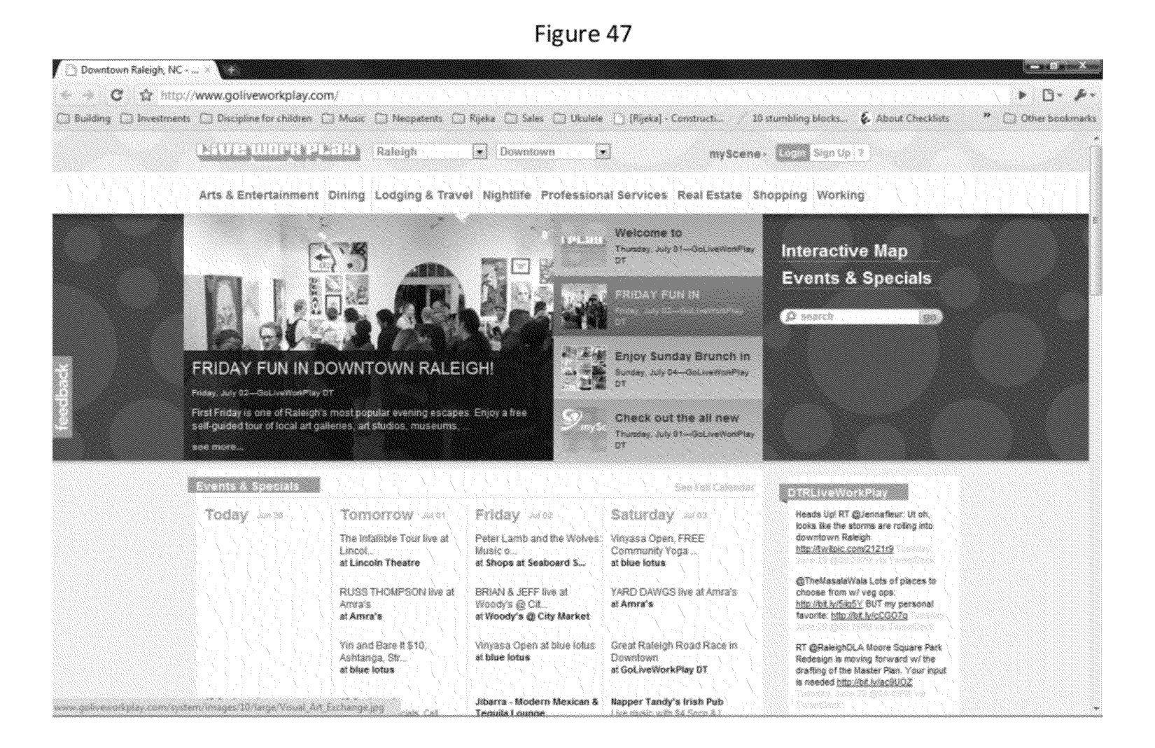

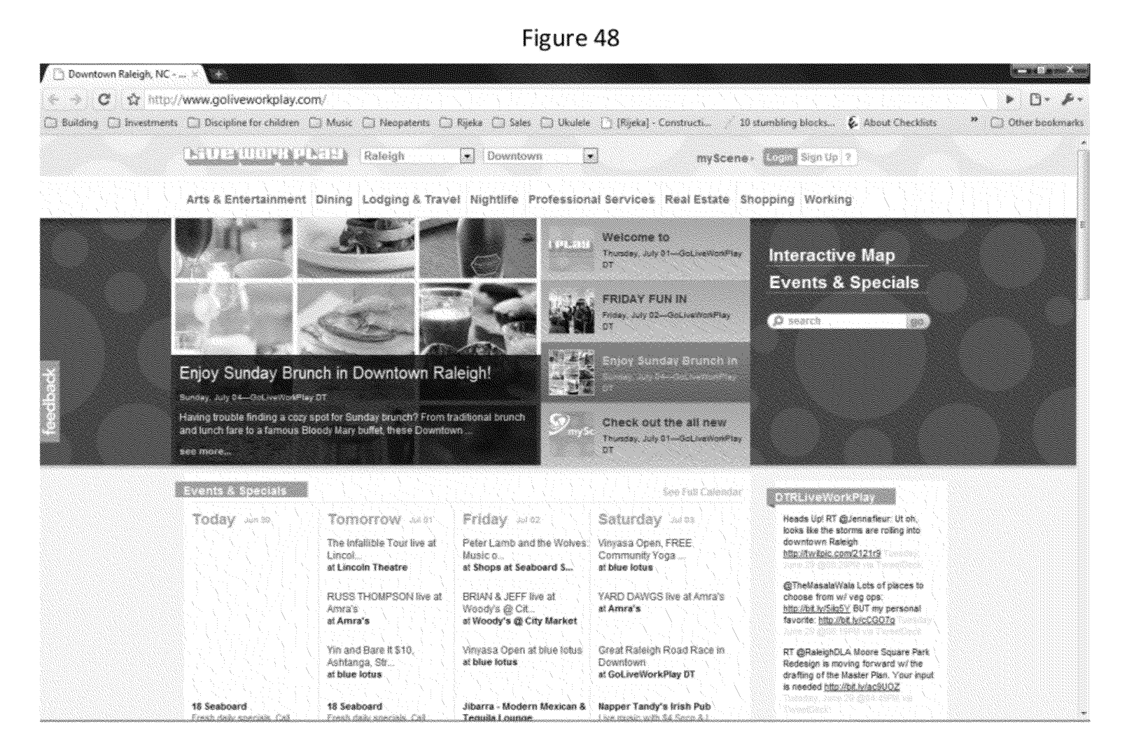

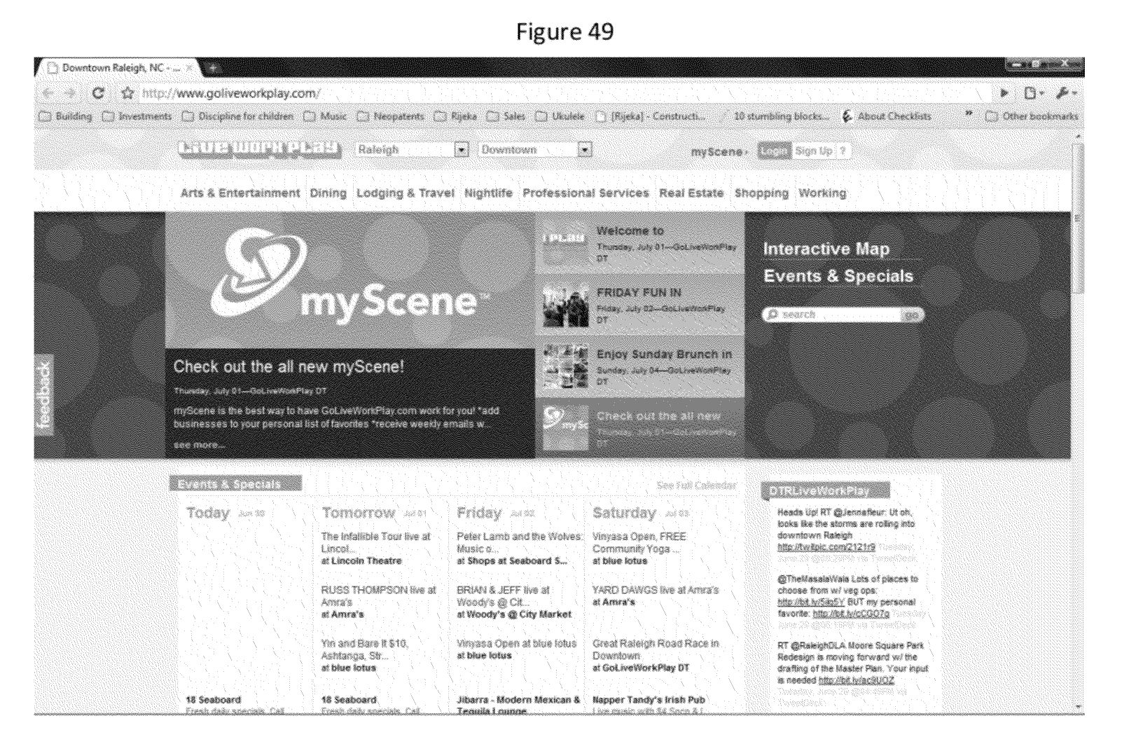

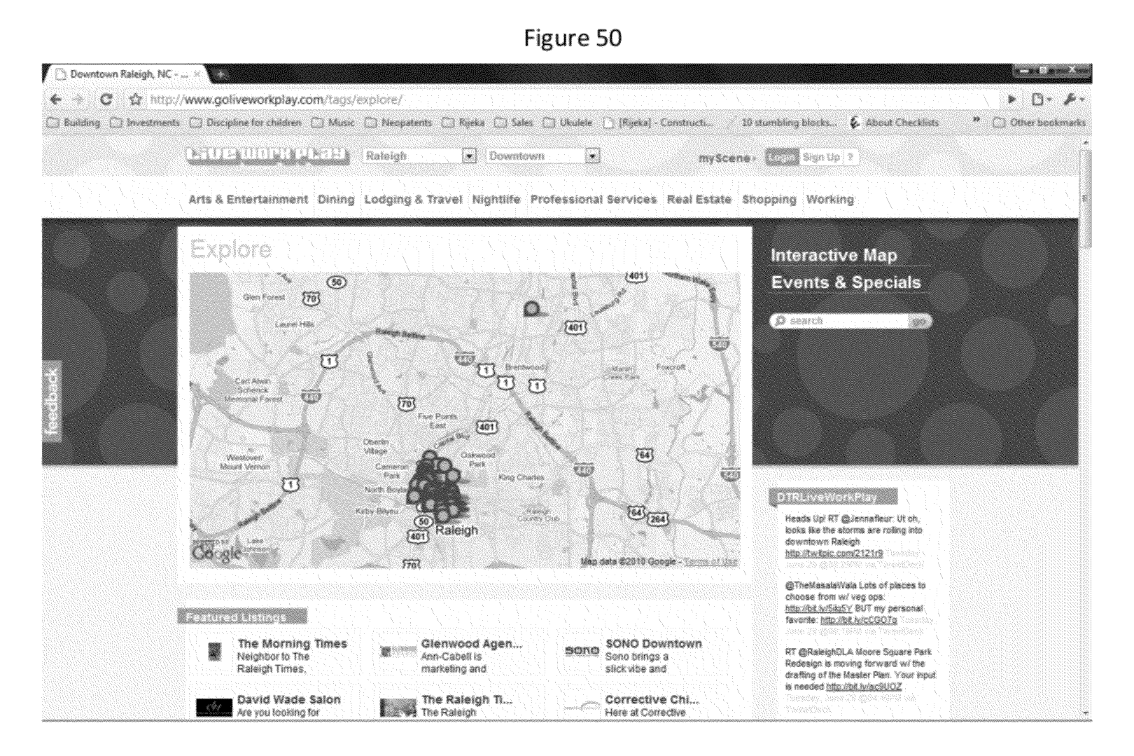

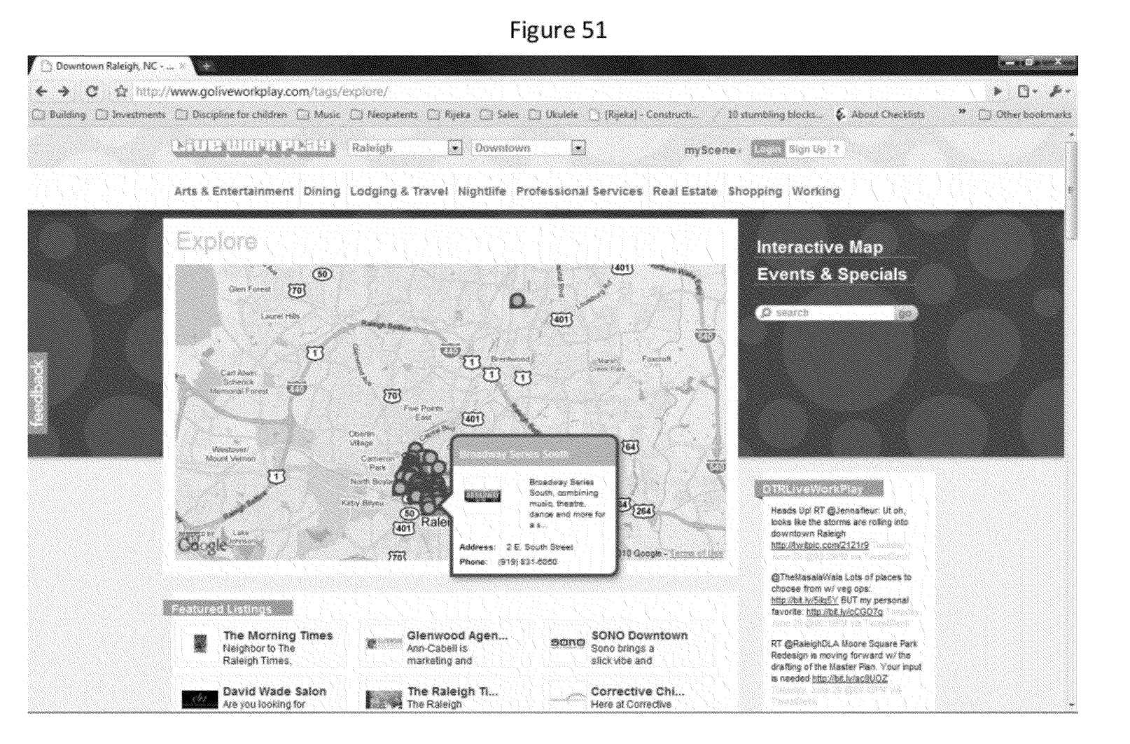

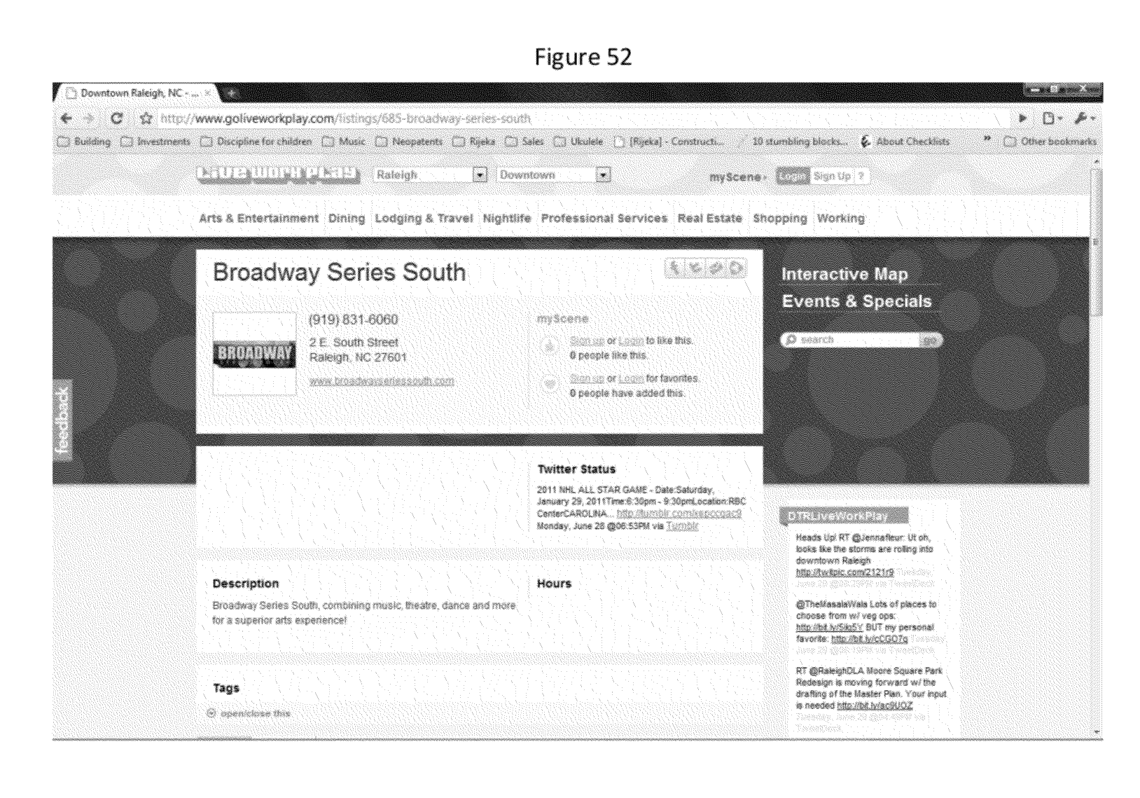

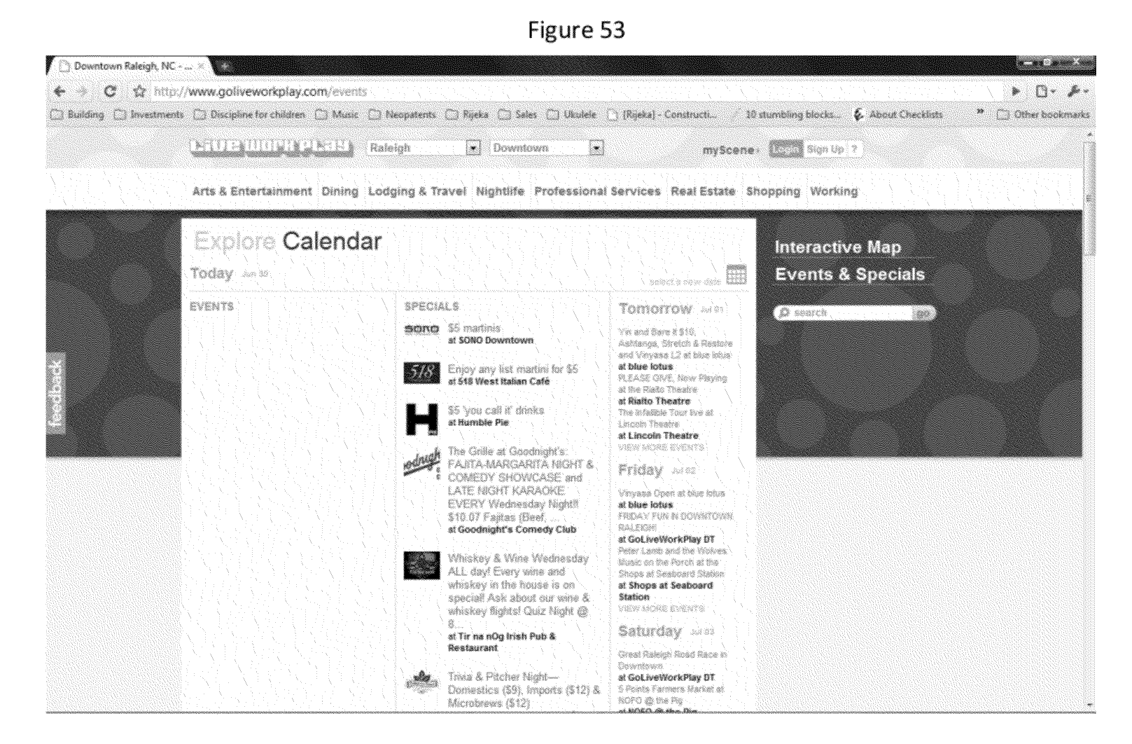

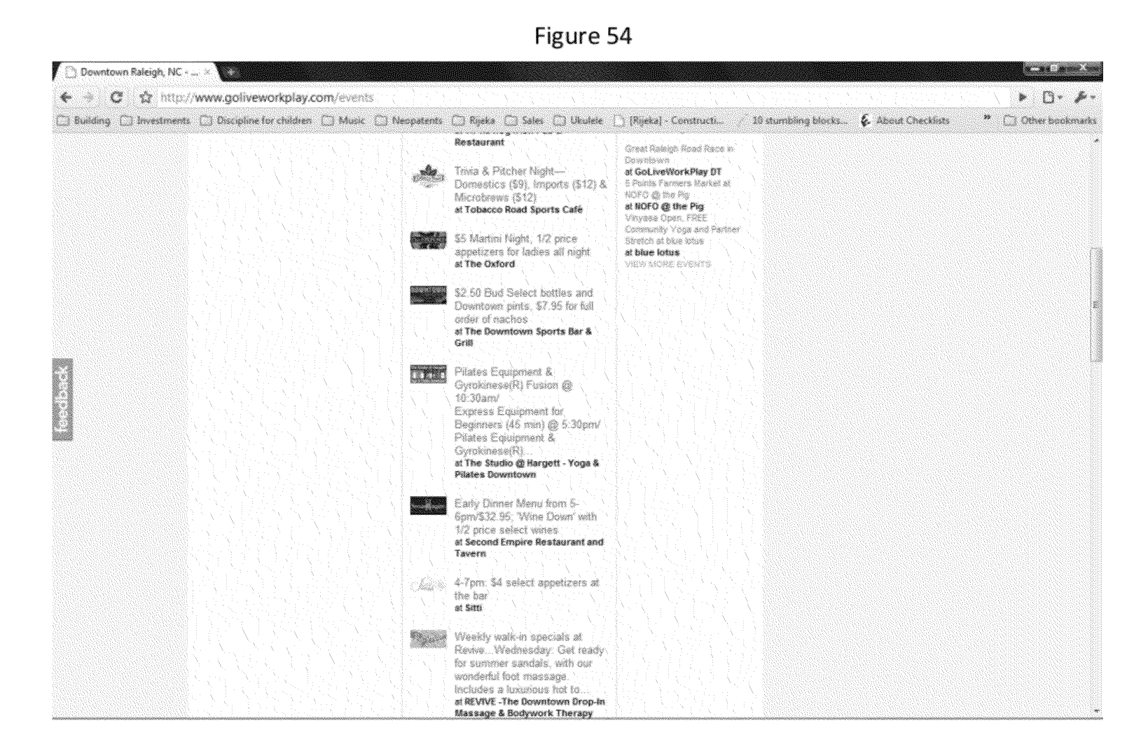

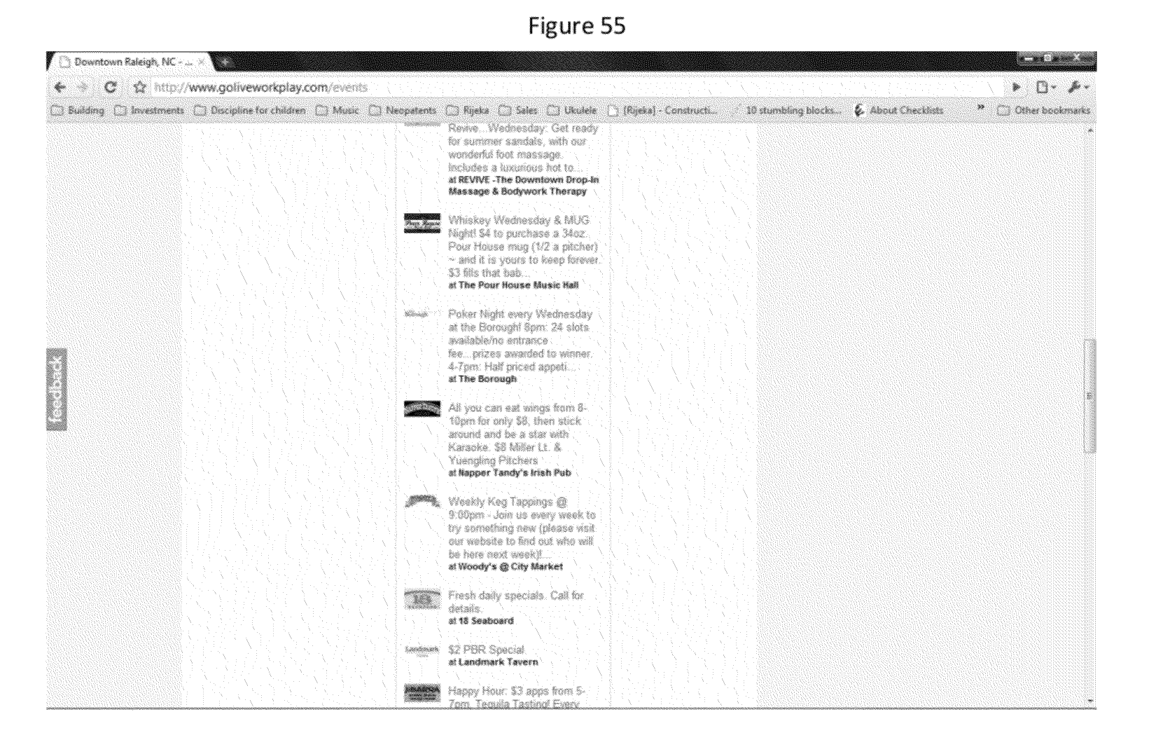

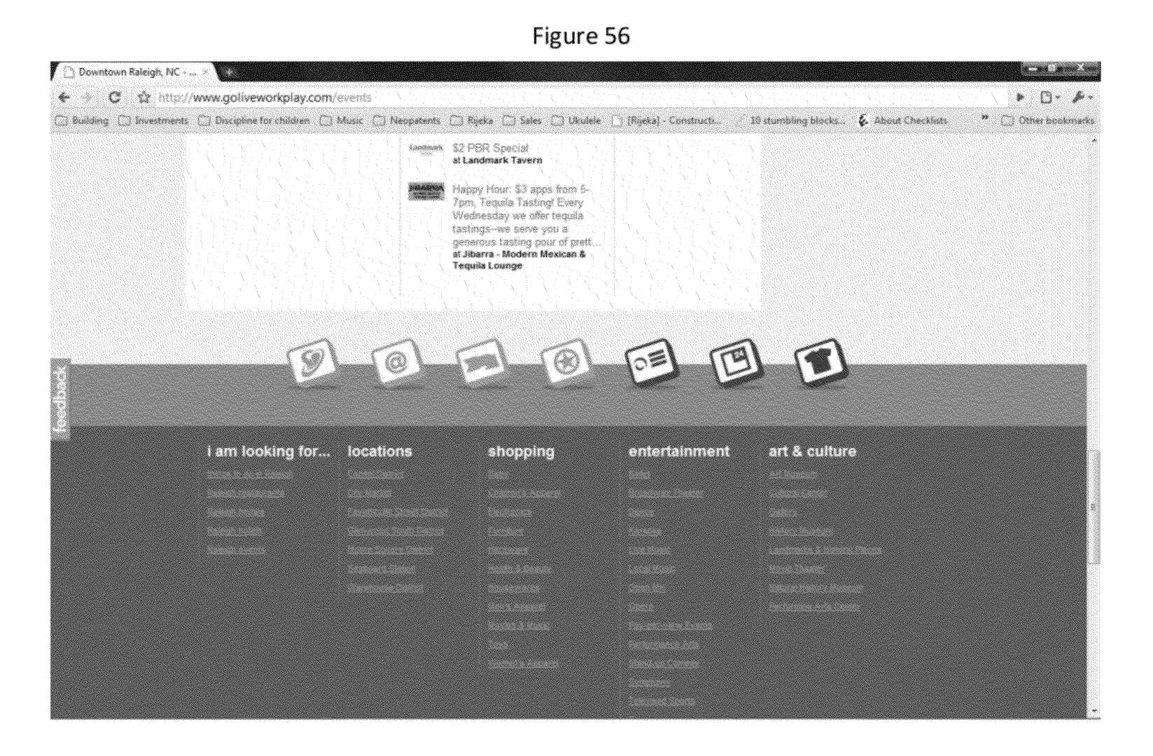

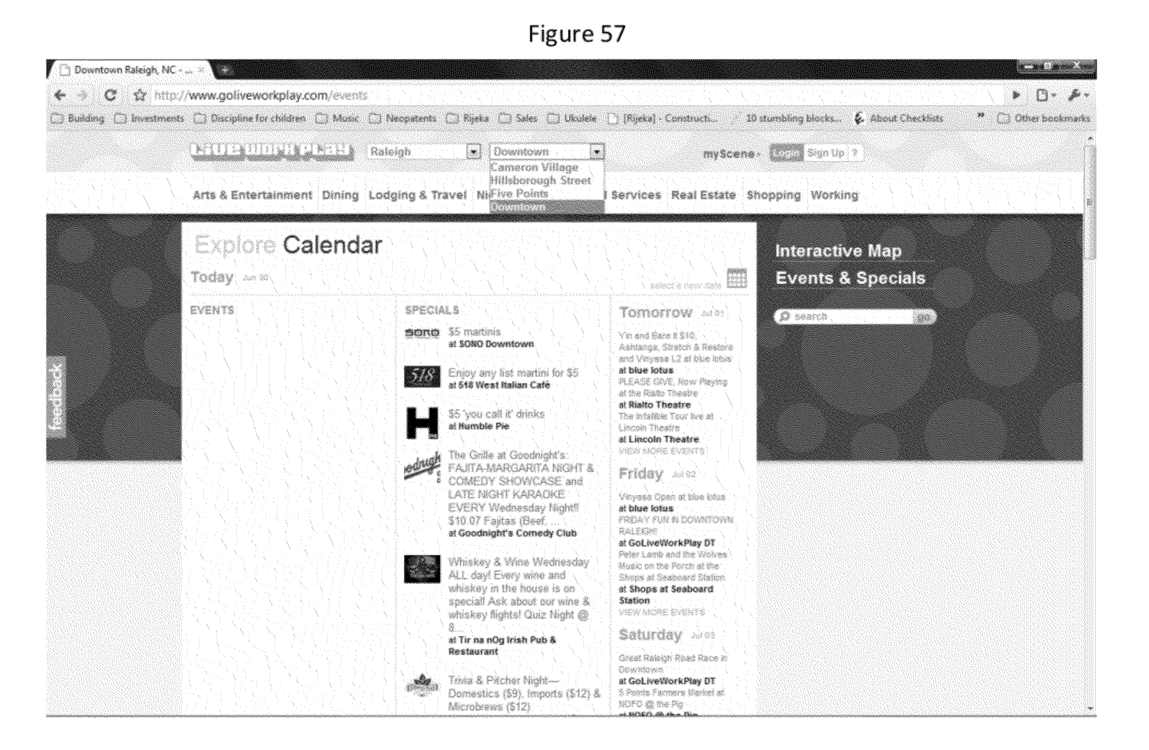

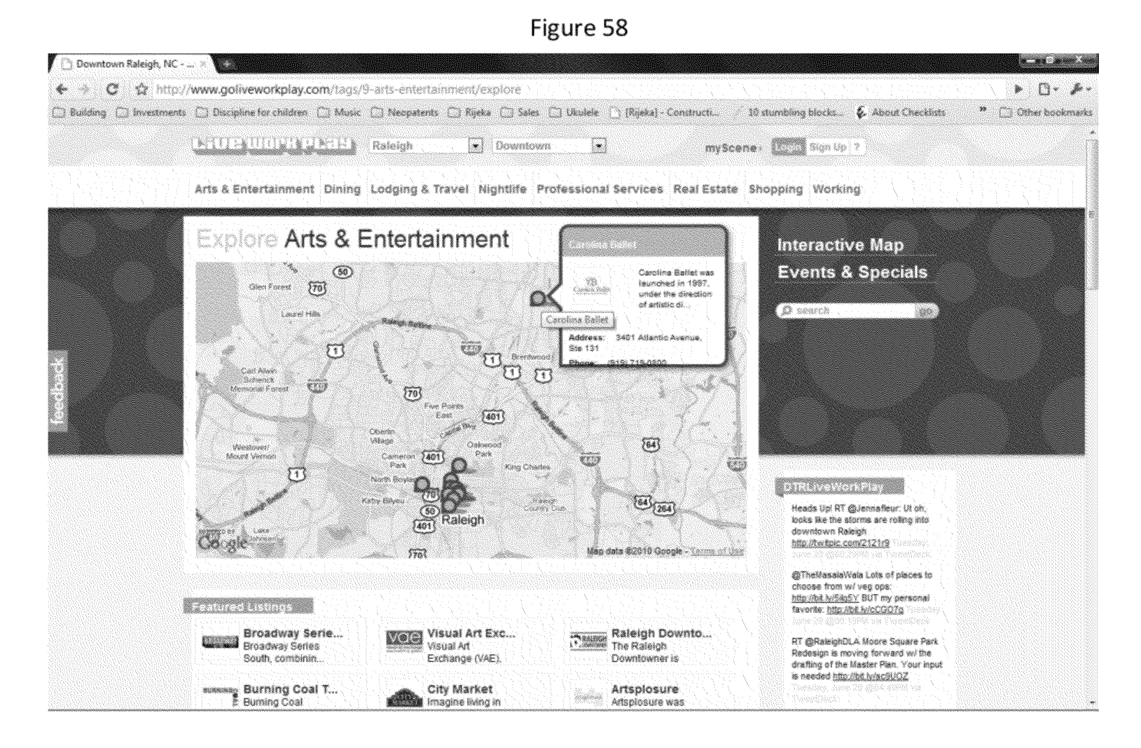

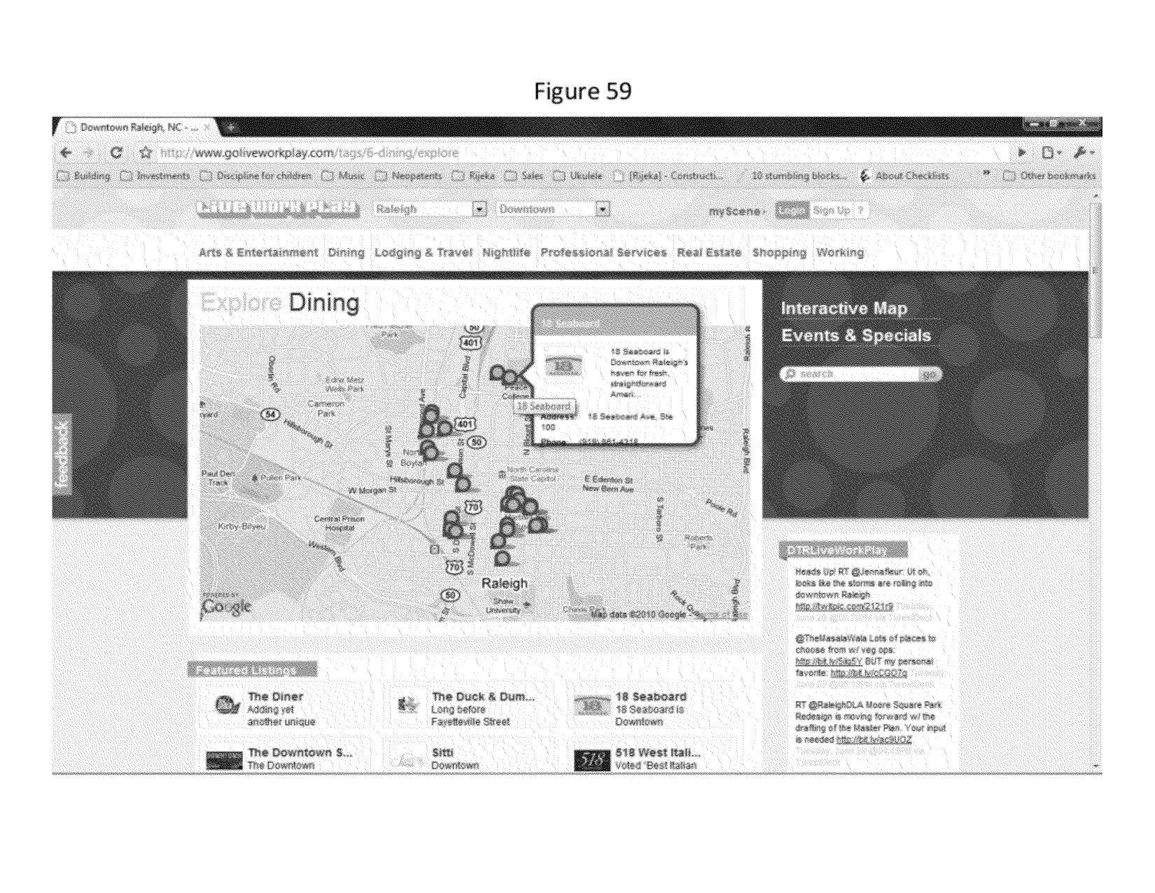

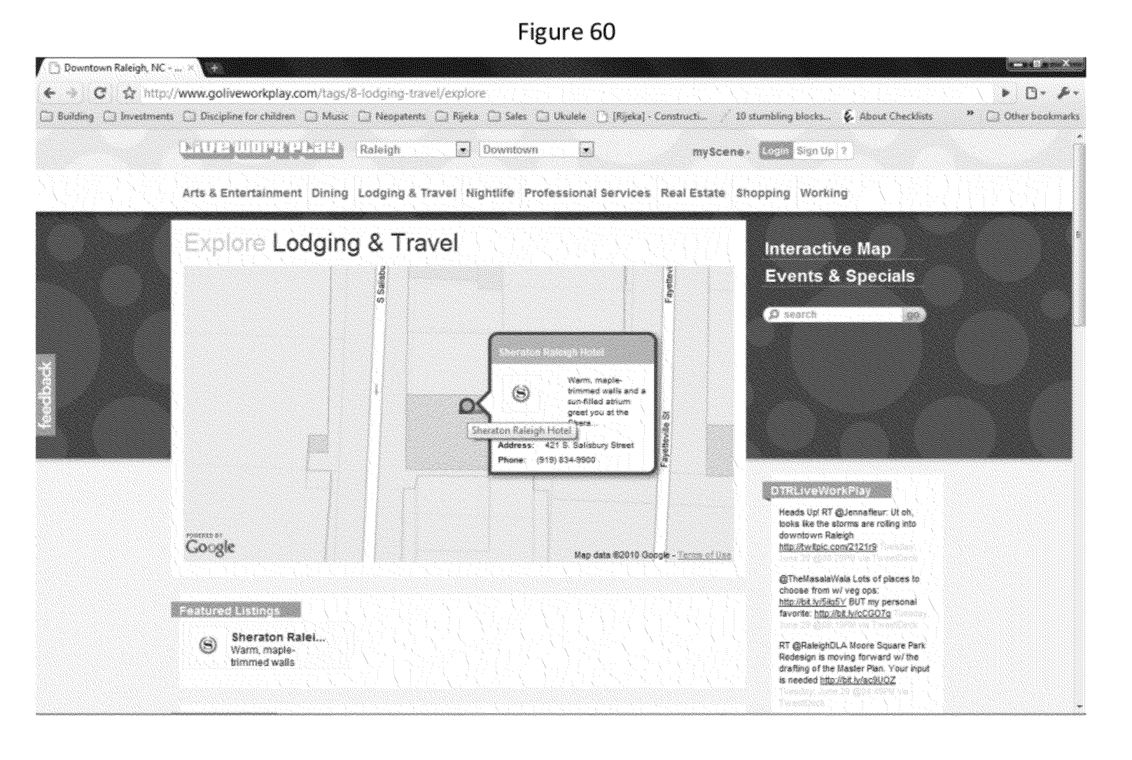

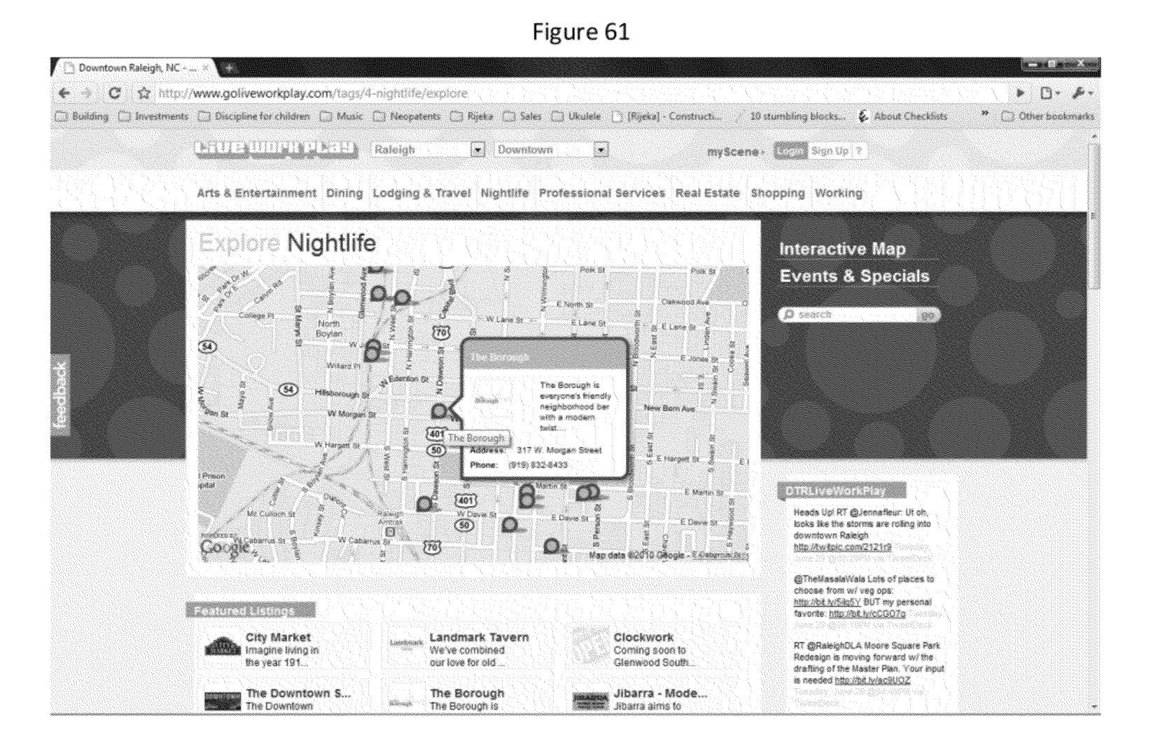

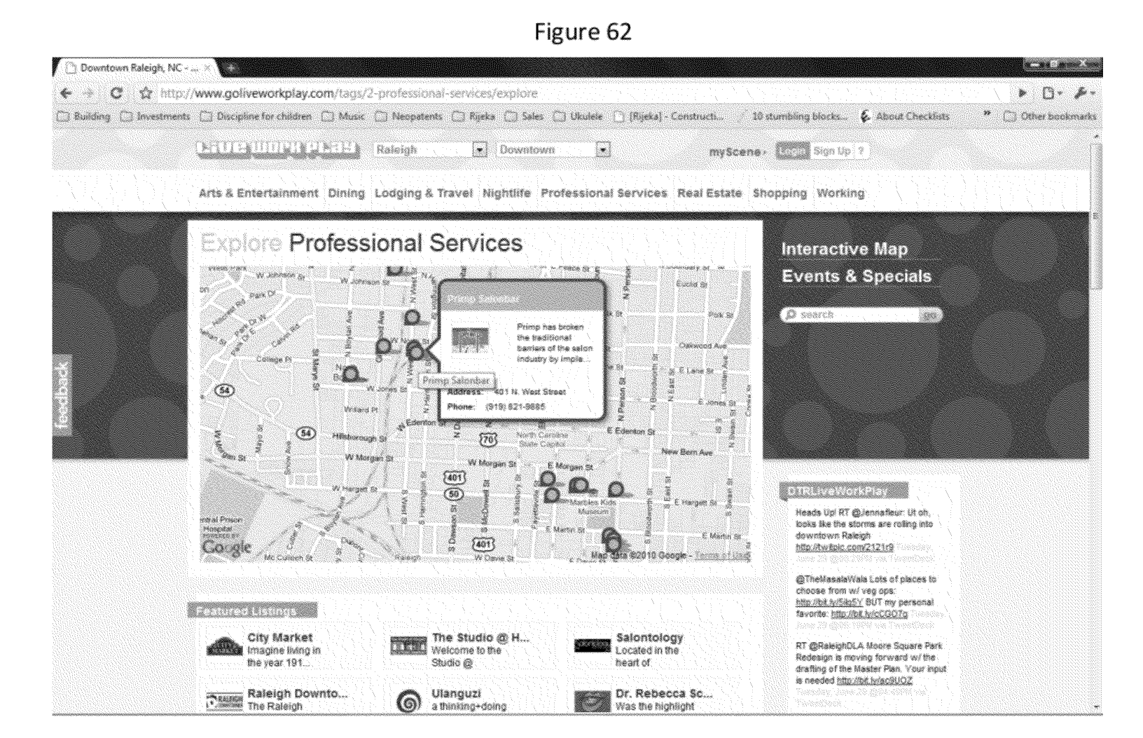

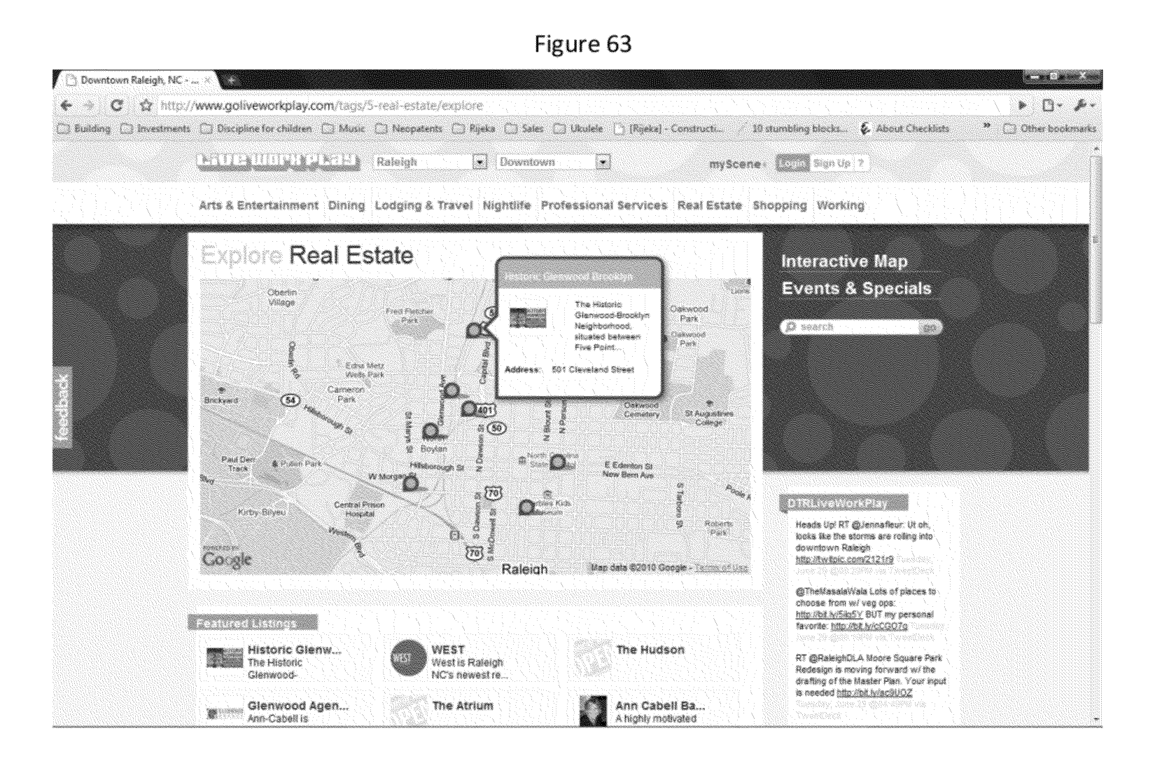

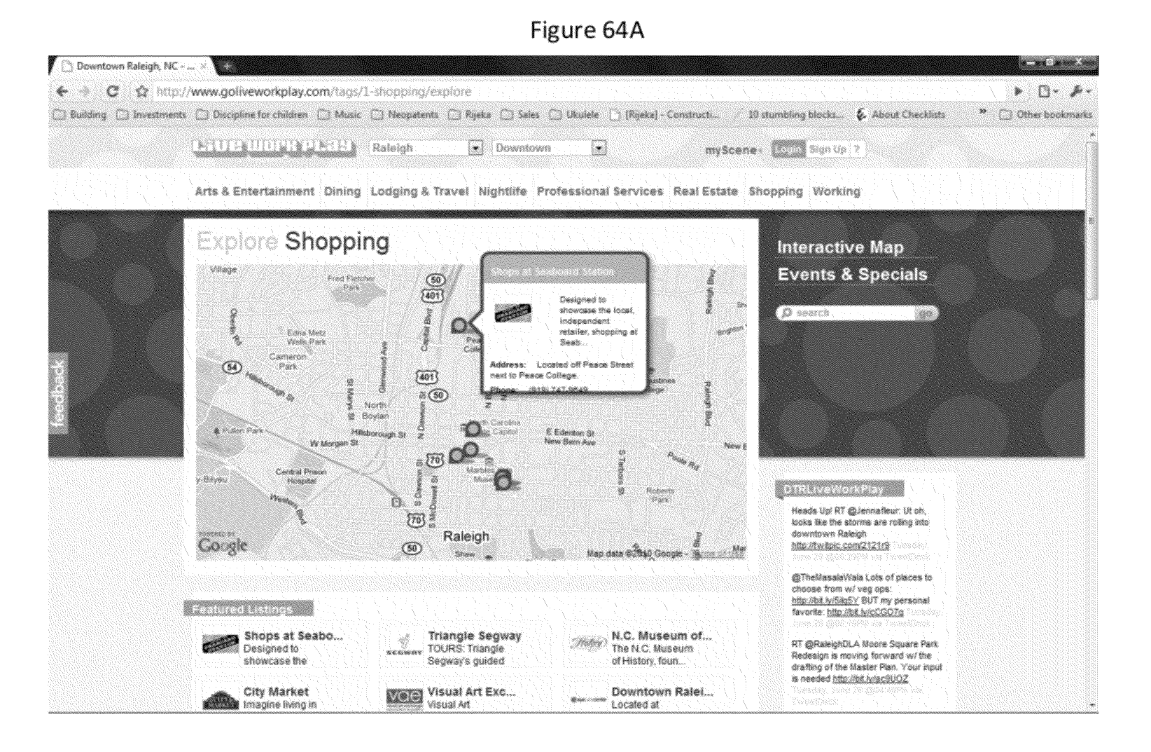

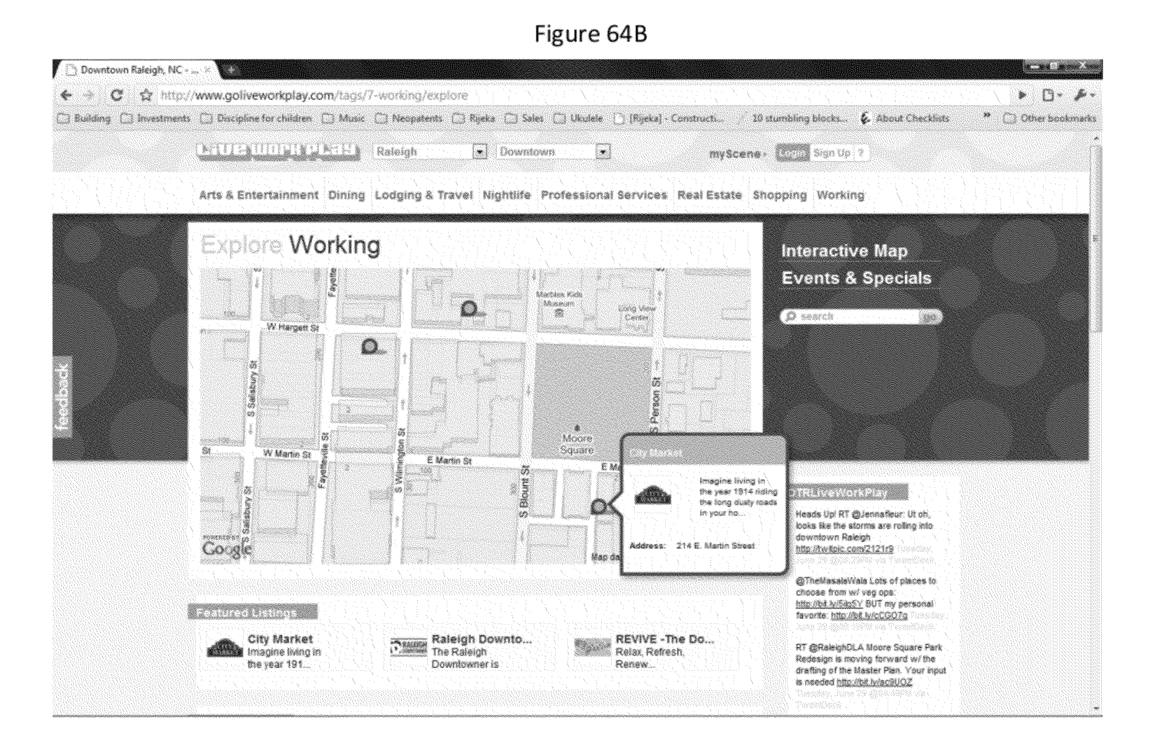

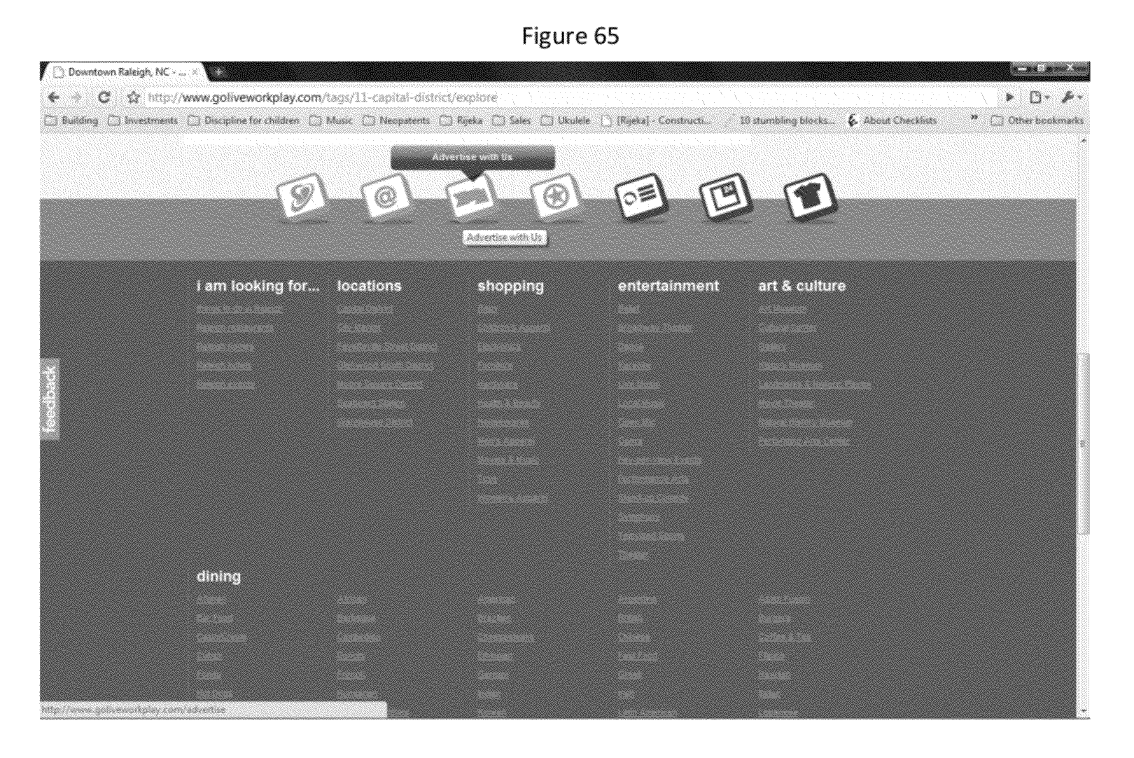

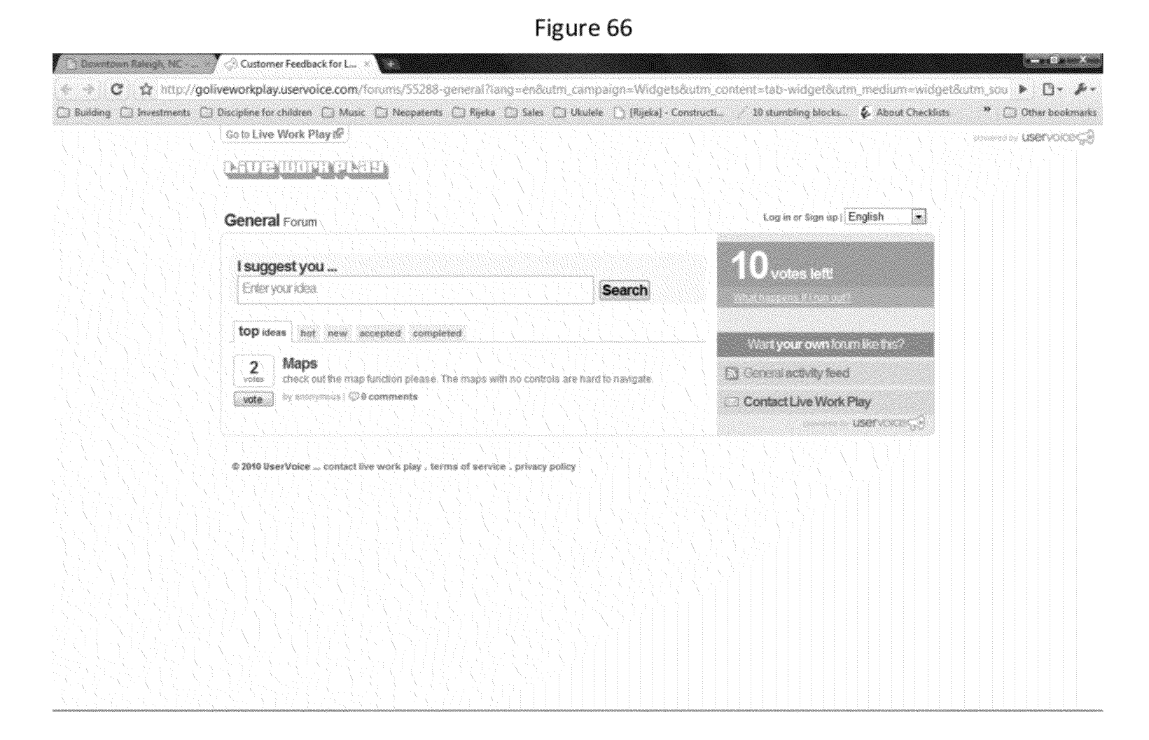

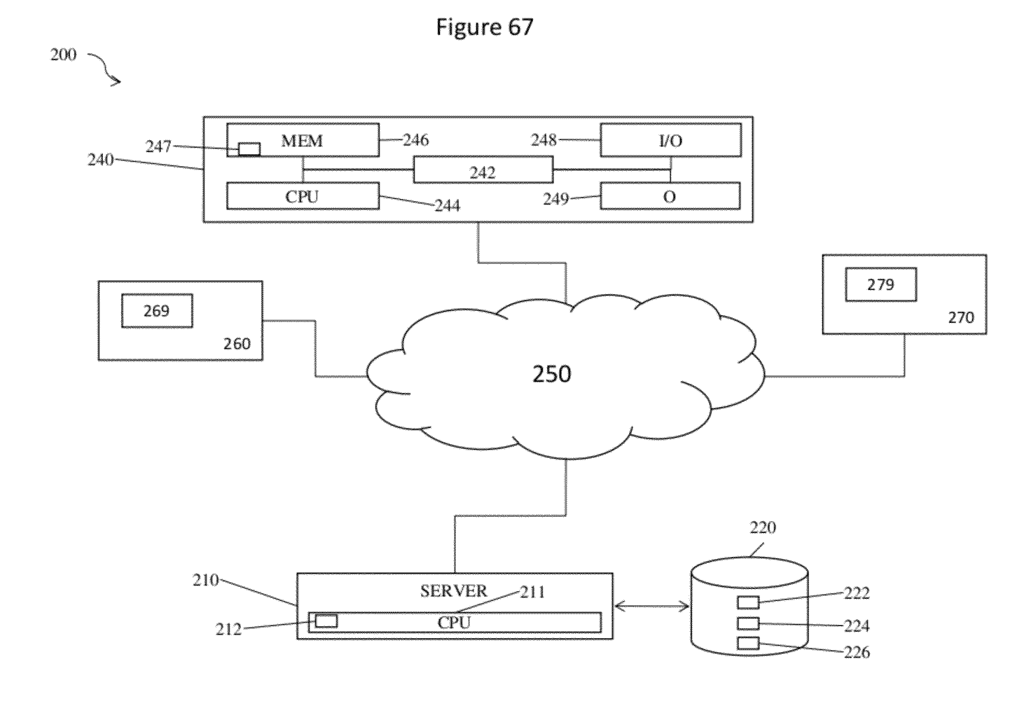

FIG. 25 is a screenshot of an interactive feedback page.

FIG. 26A is a screenshot of a website interactive user interface of one embodiment of the invention, illustrating an aspect of the present invention, displaying a calendar of local performance events.

FIG. 26B is a screenshot of a website interactive user interface of one embodiment of the invention, illustrating another aspect of the present invention, displaying a calendar of local performance events (bottom half of 1A screenshot).

FIG. 27A is a screenshot of a website interactive user interface of one embodiment of the invention, illustrating another aspect of the present invention, featuring an illustrated map of an area, highlighting dining establishments (top half of screenshot).

FIG. 27B is a screenshot of a website interactive user interface of one embodiment of the invention, illustrating another aspect of the present invention, featuring an illustrated map of an area, highlighting dining establishments.

FIG. 28A is a screenshot of a website interactive user interface of one embodiment of the invention, illustrating another aspect of the present invention, featuring details of a user-selected specific dining location, chosen from the list as shown in FIGS. 27A and 27B (top half of screenshot).

FIG. 28B is a screenshot of a website interactive user interface of one embodiment of the invention, illustrating another aspect of the present invention, featuring a video clip and further details of the user-selected specific dining location.

FIG. 29 is a screenshot of a website interactive user interface of one embodiment of the invention, illustrating another aspect of the present invention, wherein a user can chose from a tab and/or drop-down menu of several options for selecting a dining location.

FIG. 30 is a screenshot of a website interactive user interface of one embodiment of the invention, illustrating another aspect of the present invention, showing a user-selected tab option, as described in FIG. 29.

FIG. 31 is a screenshot of a website interactive user interface of one embodiment of the invention, illustrating another aspect of the present invention, showing another user-selected tab option, as described in FIG. 29.

FIG. 32 is a screenshot of a website interactive user interface of one embodiment of the invention, illustrating another aspect of the present invention, showing another user-selected tab option listing an interactive feedback page as described in FIG. 29.

FIG. 33A is a screenshot of a website interactive user interface of one embodiment of the invention, illustrating another aspect of the present invention, showing a calendar of events.

FIG. 33B is a screenshot of a website interactive user interface of one embodiment of the invention, illustrating another aspect of the present invention, showing a calendar of events.

FIG. 34 is a screenshot of a website interactive user interface of one embodiment of the invention, illustrating another aspect of the present invention, showing an interactive geographic map and featured listings in a specified area.

FIG. 35 is a screenshot of a website interactive user interface of one embodiment of the invention, illustrating another aspect of the present invention, showing a geographic map of a specific, user-selected area.

FIG. 36 is a screenshot of a website interactive user interface of one embodiment of the invention, illustrating a calendar of events listings page.

FIG. 37A is a screenshot of a website interactive user interface of an embodiment of the present invention, highlighting a specific event, description tab details.

FIG. 37B is a screenshot of a website interactive user interface of an embodiment of the present invention, highlighting a map tab with geographic details.

FIG. 38 is a screenshot of a website interactive user interface of one embodiment of the invention, illustrating the events page and mouse-over location or event selection for interactive customer user.

FIG. 39 is a screenshot of a website interactive user interface of one embodiment of the invention, illustrating a user-selected event calendar with details including locations of events.

FIG. 40 is a screenshot of a website interactive user interface of one embodiment of the invention, illustrating an explore page, highlighting a user-selected shopping location and a location-specific calendar.

FIG. 41 is a screenshot of a website interactive user interface of one embodiment of the invention, illustrating an explore page, highlighting another user-selected location and a location-specific calendar.

FIG. 42 is a screenshot of a website interactive user interface of one embodiment of the invention, illustrating an explore events page, highlighting another user-selected location and a location-specific calendar.

FIG. 43 is a screenshot of a website interactive user interface of one embodiment of the invention, illustrating a welcome message for at least one remote user to access and interact with the systems and methods of the present invention.

FIG. 44 is a screenshot of a website interactive user interface of one embodiment of the invention, illustrating another aspect of the present invention.

FIG. 45 is a screenshot of a website interactive user interface of one embodiment of the invention, illustrating another aspect of the present invention.

FIG. 46 is a screenshot of a website interactive user interface of one embodiment of the invention, illustrating another aspect of the present invention

FIG. 47 is a screenshot of a website interactive user interface of one embodiment of the invention, illustrating another aspect of the present invention, showing a first highlight event.

FIG. 48 is a screenshot of a website interactive user interface of one embodiment of the invention, illustrating another aspect of the present invention, showing a second highlight event.

FIG. 49 is a screenshot of a website interactive user interface of one embodiment of the invention, illustrating another aspect of the present invention, showing a third highlight event.

FIG. 50 is a screenshot of a website interactive user interface of one embodiment of the invention, illustrating another aspect of the present invention, showing an interactive geographic map.

FIG. 51 is a screenshot of a website interactive user interface of one embodiment of the invention, illustrating another aspect of the present invention, showing an explore page including a pop-up message.

FIG. 52 is a screenshot of a website interactive user interface of one embodiment of the invention, illustrating a listings page.

FIG. 53 is a screenshot of a website interactive user interface of one embodiment of the invention, illustrating an events page.

FIGS. 54-56 are screenshots of a website interactive user interface of an embodiment of the present invention, illustrating other aspects of the event page of FIG. 53.

FIG. 57 is a screenshot of a website interactive user interface of one embodiment of the invention, illustrating drop-down location selection for interactive customer user selection of a location to be included in her/his customized personal settings.

FIG. 58 is a screenshot of a website interactive user interface of one embodiment of the invention, illustrating an explore arts and entertainment page, including at least one pop-up message.

FIG. 59 is a screenshot of a website interactive user interface of one embodiment of the invention, illustrating an explore dining page.

FIG. 60 is a screenshot of a website interactive user interface of one embodiment of the invention, illustrating an explore travel and lodging page.

FIG. 61 is a screenshot of a website interactive user interface of one embodiment of the invention, illustrating an explore nightlife page.

FIG. 62 is a screenshot of a website interactive user interface of one embodiment of the invention, illustrating an explore professional services page.

FIG. 63 is a screenshot of a website interactive user interface of one embodiment of the invention, illustrating an explore real estate page.

FIGS. 64A-64B are screenshots of a website interactive user interface of one embodiment of the invention, illustrating an explore shopping page.

FIG. 65 is a screenshot of a website interactive user interface of one embodiment of the invention, illustrating an explore working page.

FIG. 66 is a screenshot of a website interactive user interface of one embodiment of the invention, illustrating customer service icons, including pop-up message box.

FIG. 67 is an interactive feedback page.

### DETAILED DESCRIPTION OF THE INVENTION

Referring now to the drawings in general, the illustrations are for the purpose of describing a preferred embodiment of the invention and are not intended to limit the invention thereto.

The present invention provides for a systems and methods for network-based calendar availability notification and interactive acceptance by users associated with service providers, businesses, and/or individuals.

The systems and methods of the present invention also provide for automated coordination of events and activities for customer users associated with service provider users of the system, such as restaurants, businesses, and/or service provider individuals. Users may be predetermined (pre-registered with the system for their preferences) or not. Also, preferably the systems and methods may be provided for cloud or virtualized systems, such as a web-based hosted solution.

Systems and methods of the present invention may include personal events and activities and/or business-based events or activities, for notification and coordination within the system automatically among customer users, for example, within a social network of a first customer user and her/his associated customer users (such as friends), the first customer user creates an event and a corresponding notice and/or an invitation for the predetermined or custom-selected additional customer users that are associated within the social network of the first customer user.

Preferably, the systems and methods of the present invention automatically manage notification of special events, special offerings, and openings (such as for reservations or parties) by service provider users to matched customer users within a network (predetermined, opt-in, or opt-out), such as, for example but not limitation, a social network.

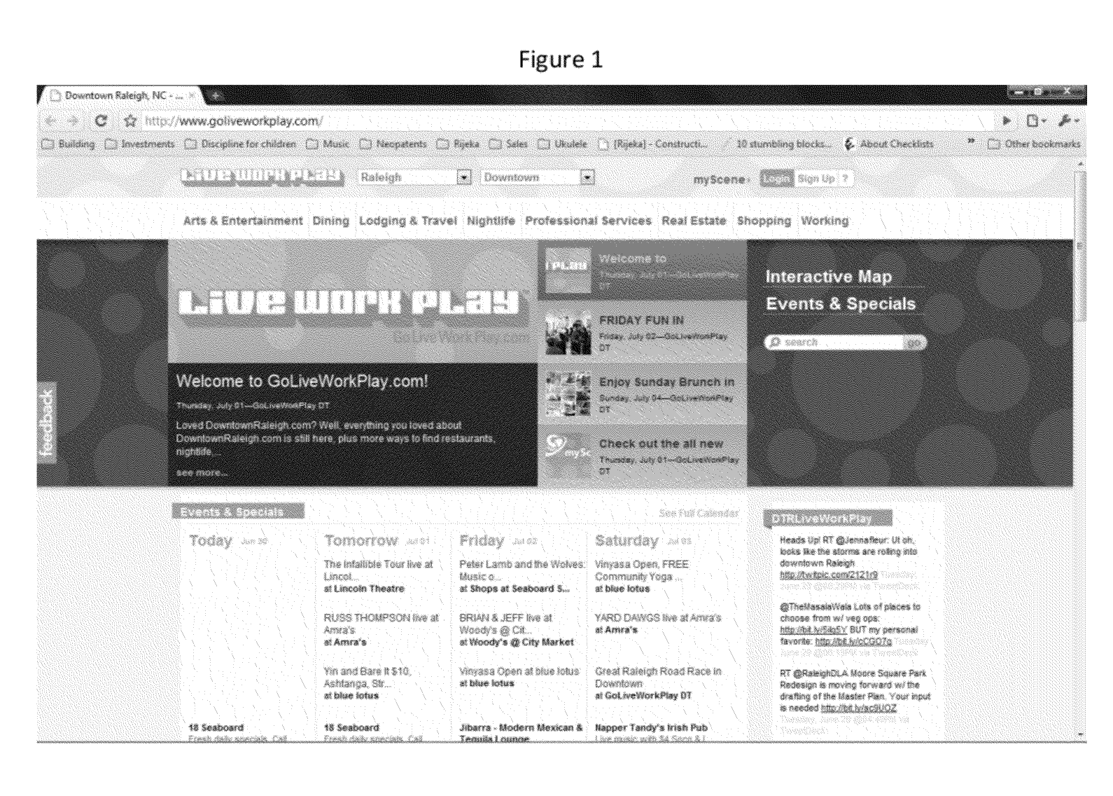

FIG. 1 is a screenshot of a website interactive user interface of one embodiment of the invention, illustrating a welcome message for at least one remote user to access and interact with the systems and methods of the present invention.

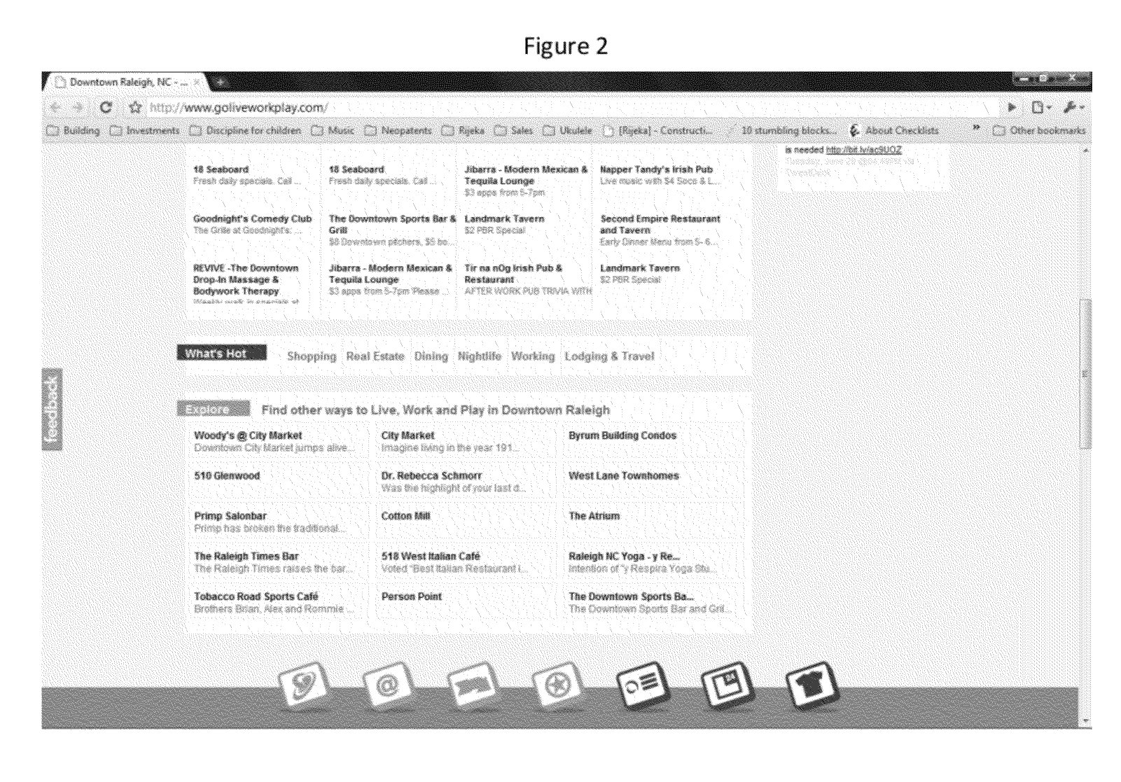

FIG. 2 is a screenshot of a website interactive user interface of one embodiment of the invention, illustrating another aspect of the present invention.

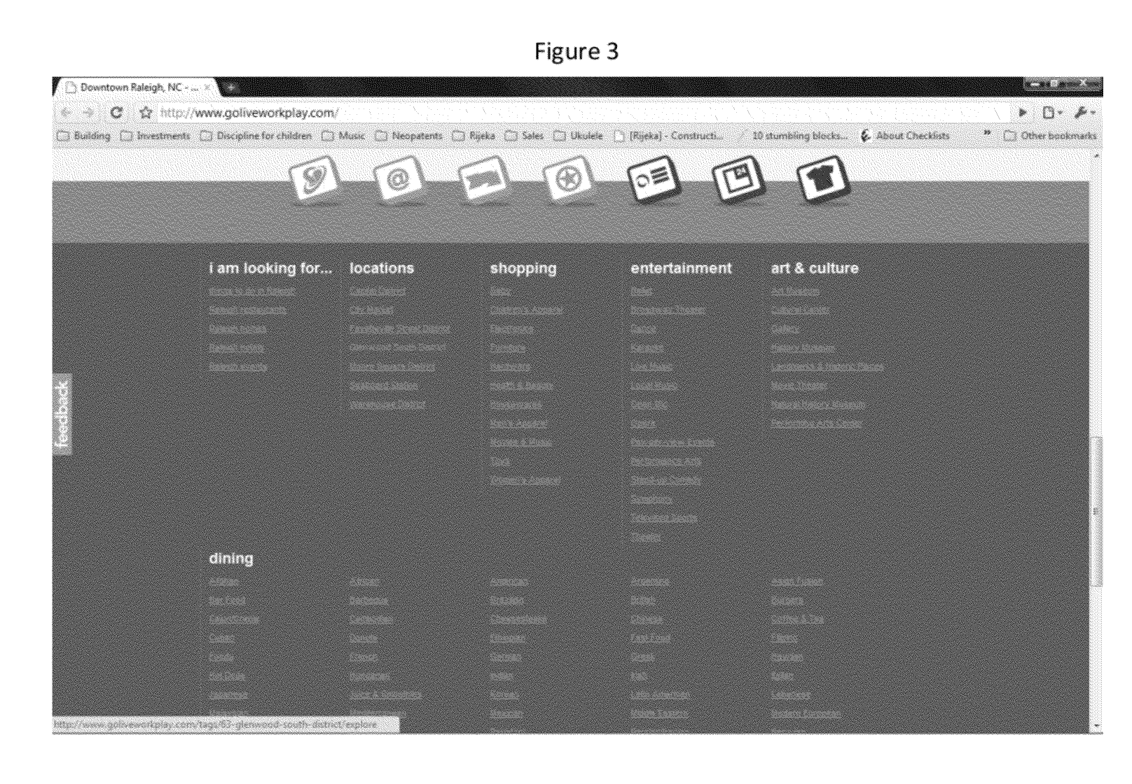

FIG. 3 is a screenshot of a website interactive user interface of one embodiment of the invention, illustrating another aspect of the present invention.

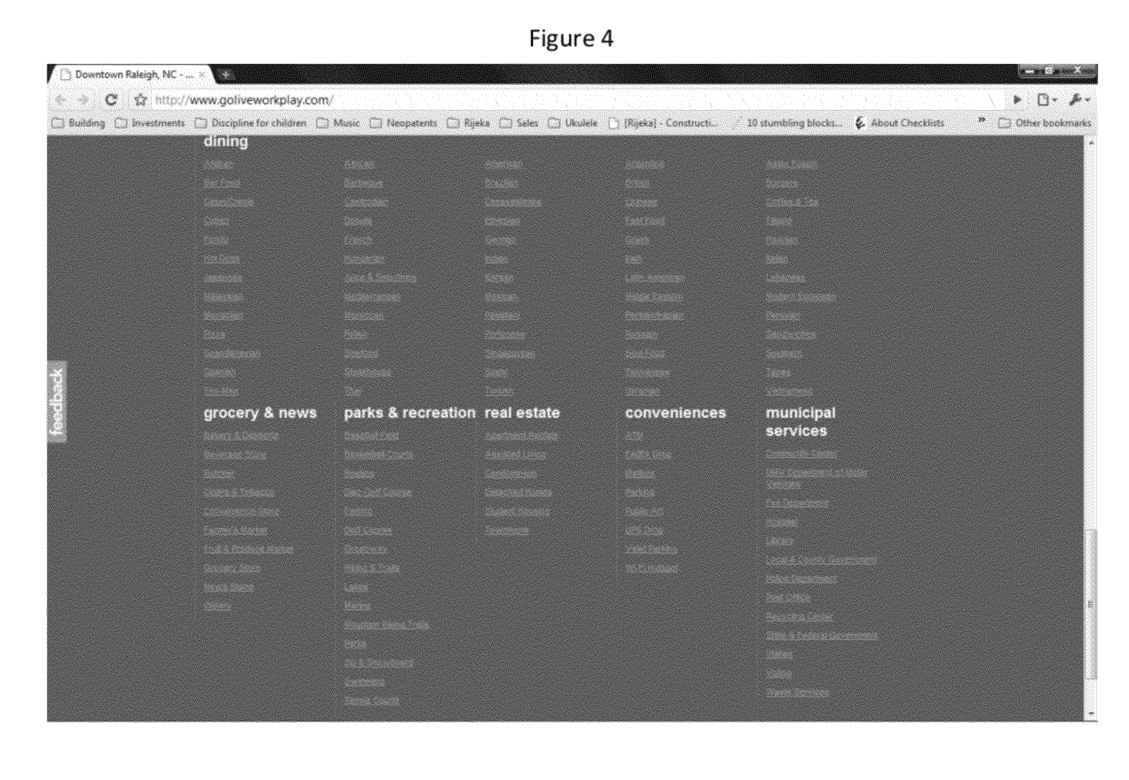

FIG. 4 is a screenshot of a website interactive user interface of one embodiment of the invention, illustrating another aspect of the present invention

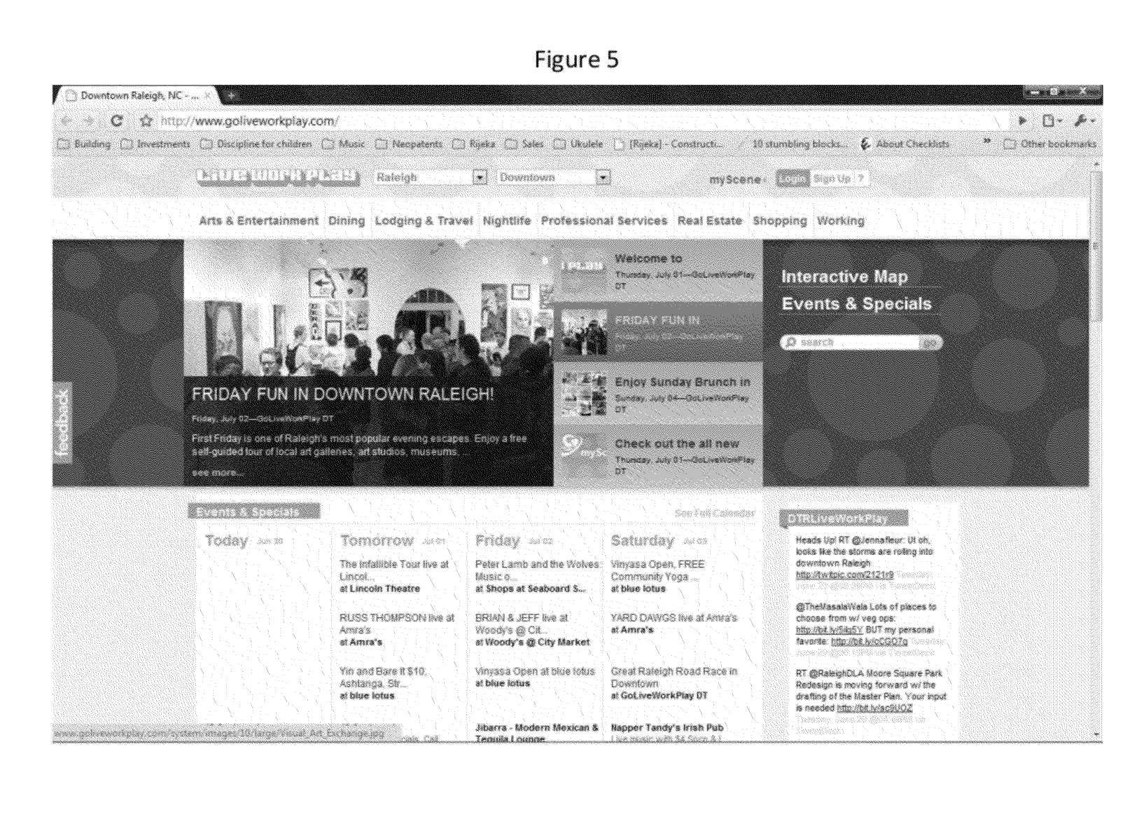

FIG. 5 is a screenshot of a website interactive user interface of one embodiment of the invention, illustrating another aspect of the present invention, showing a first highlight event.

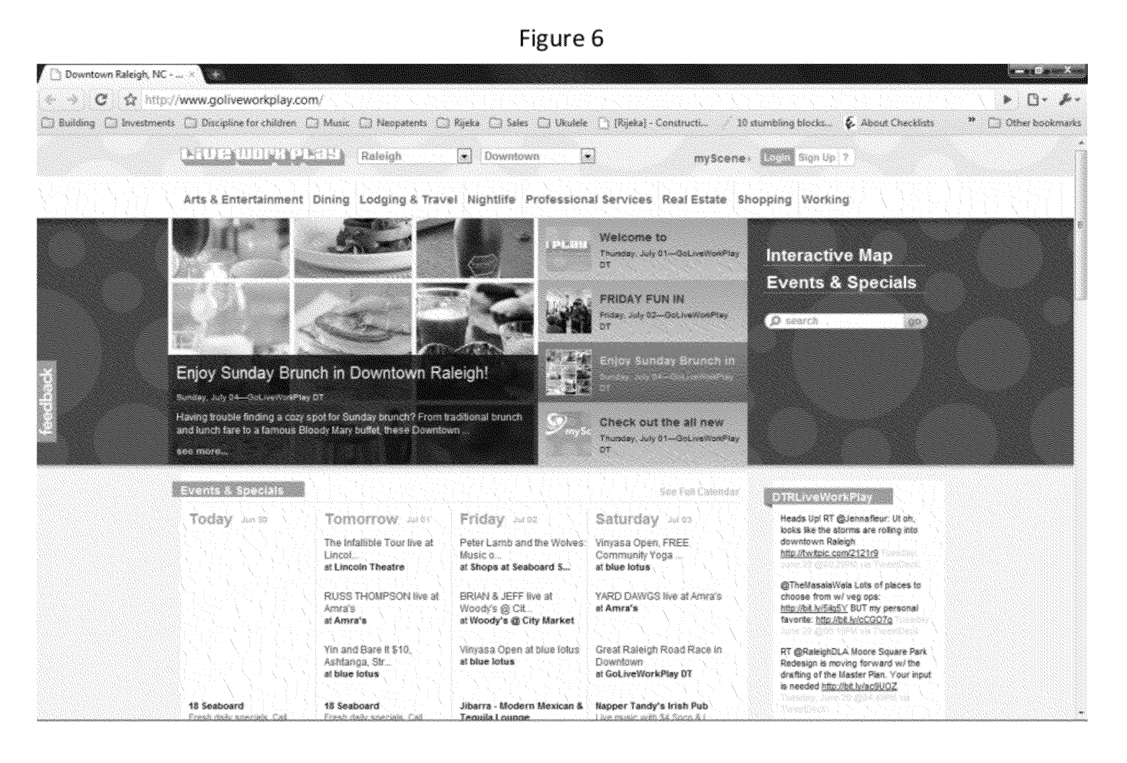

FIG. 6 is a screenshot of a website interactive user interface of one embodiment of the invention, illustrating another aspect of the present invention, showing a second highlight event.

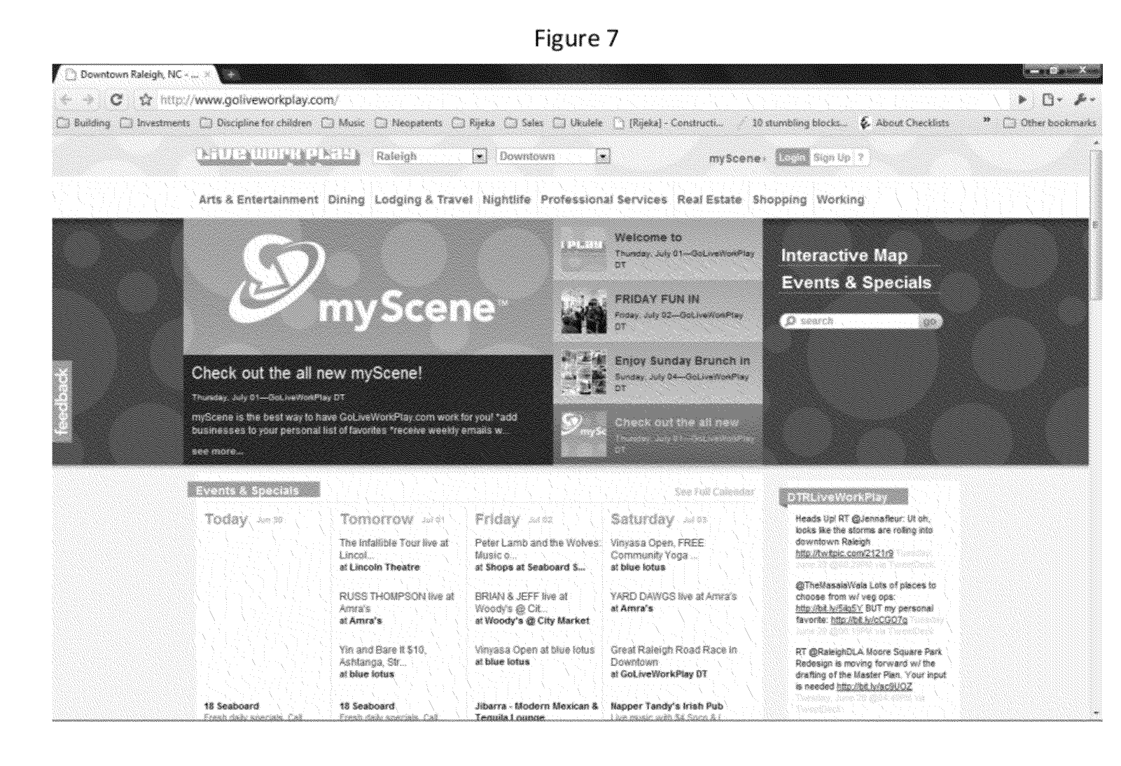

FIG. 7 is a screenshot of a website interactive user interface of one embodiment of the invention, illustrating another aspect of the present invention, showing a third highlight event.

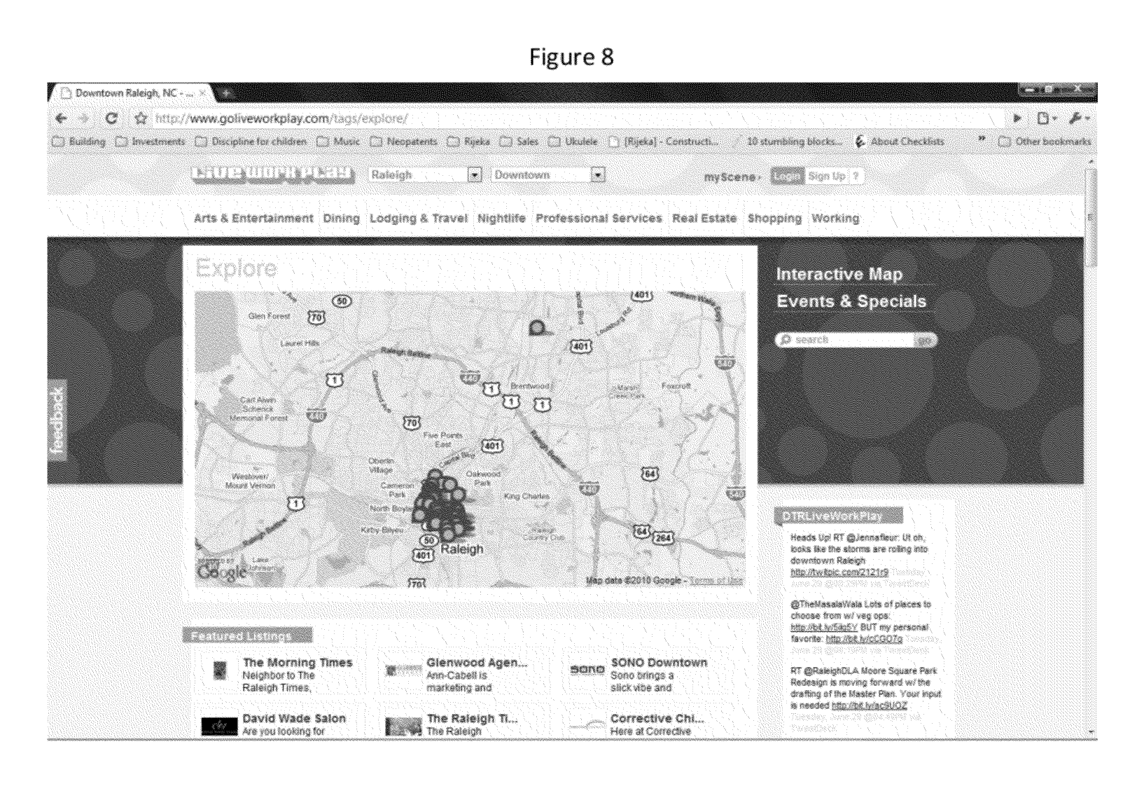

FIG. 8 is a screenshot of a website interactive user interface of one embodiment of the invention, illustrating another aspect of the present invention, showing an interactive geographic map.

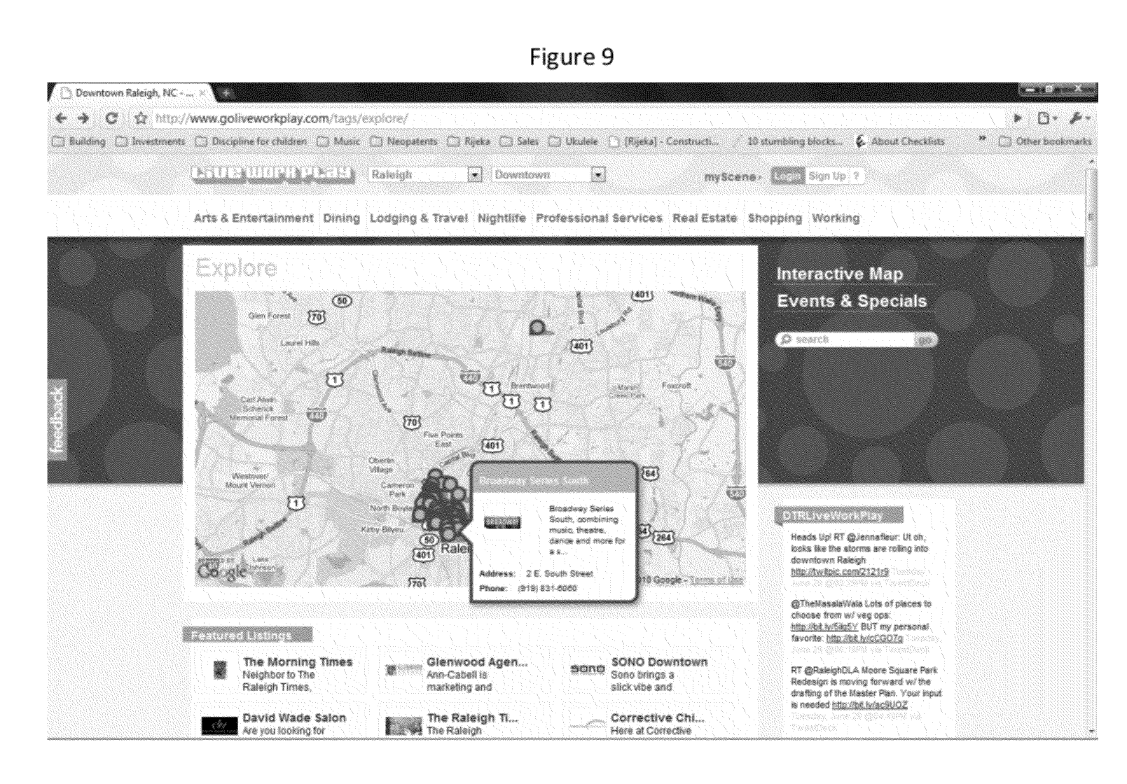

FIG. 9 is a screenshot of a website interactive user interface of one embodiment of the invention, illustrating another aspect of the present invention, showing an explore page including a pop-up message.

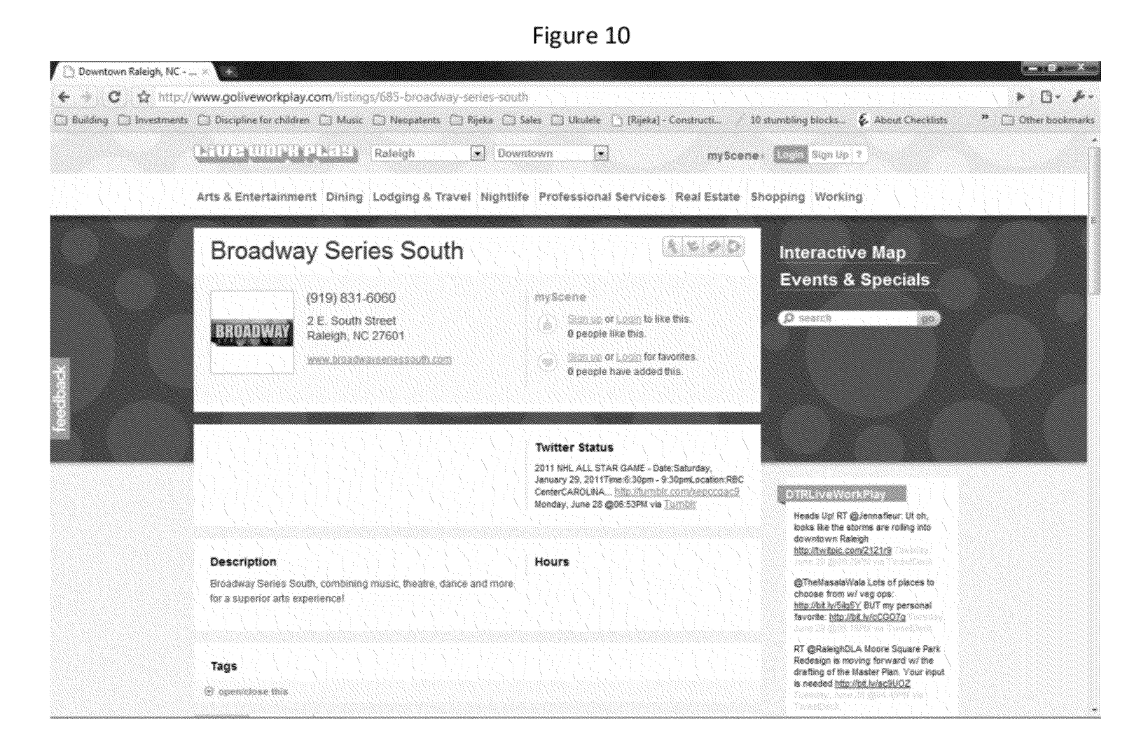

FIG. 10 is a screenshot of a website interactive user interface of one embodiment of the invention, illustrating a listings page.

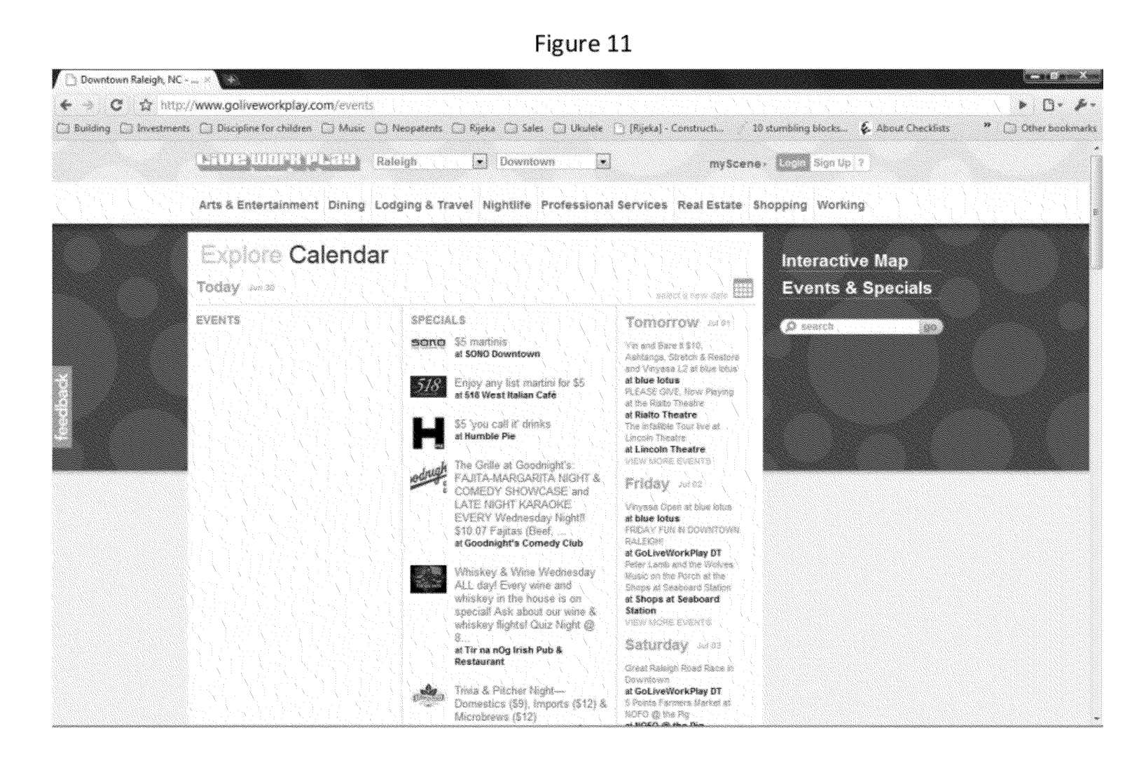

FIG. 11 is a screenshot of a website interactive user interface of one embodiment of the invention, illustrating an events page.

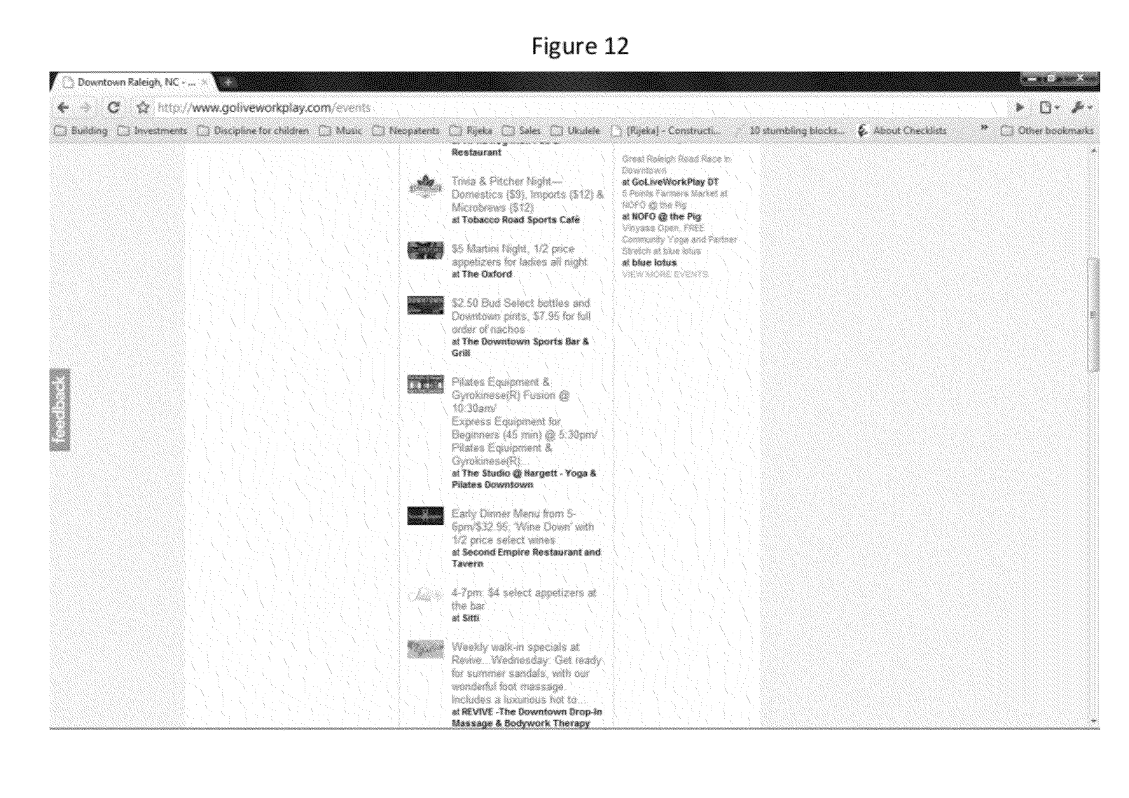

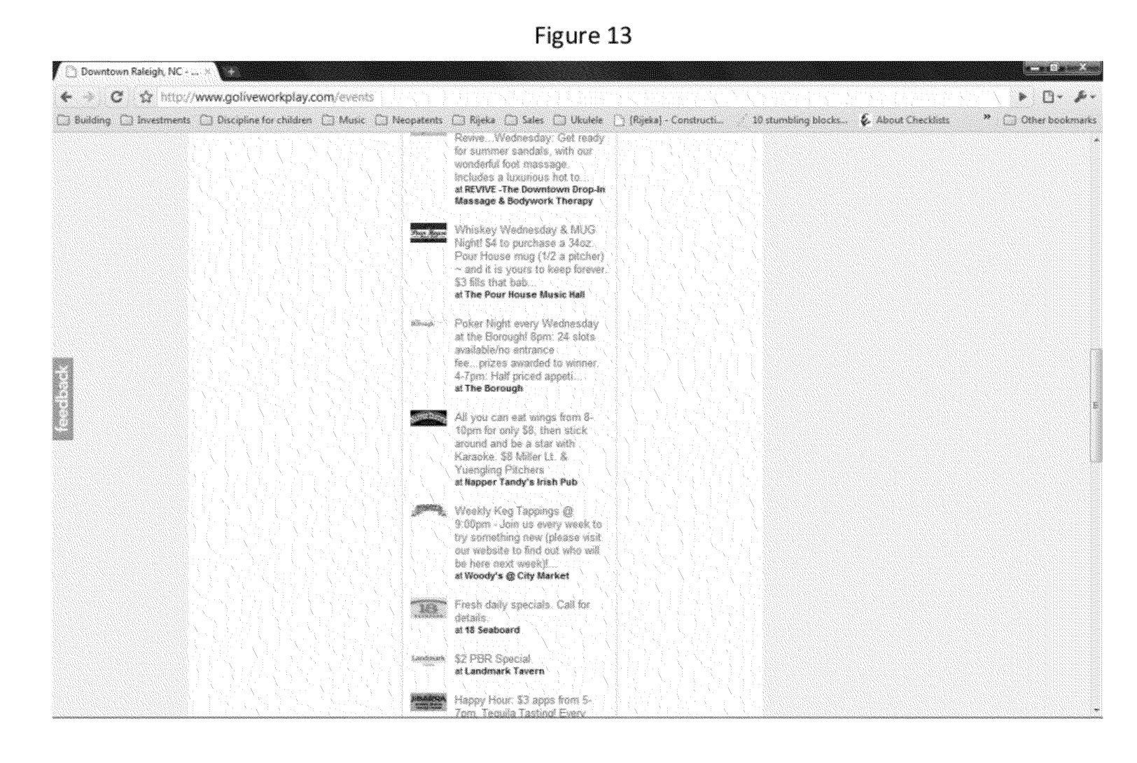

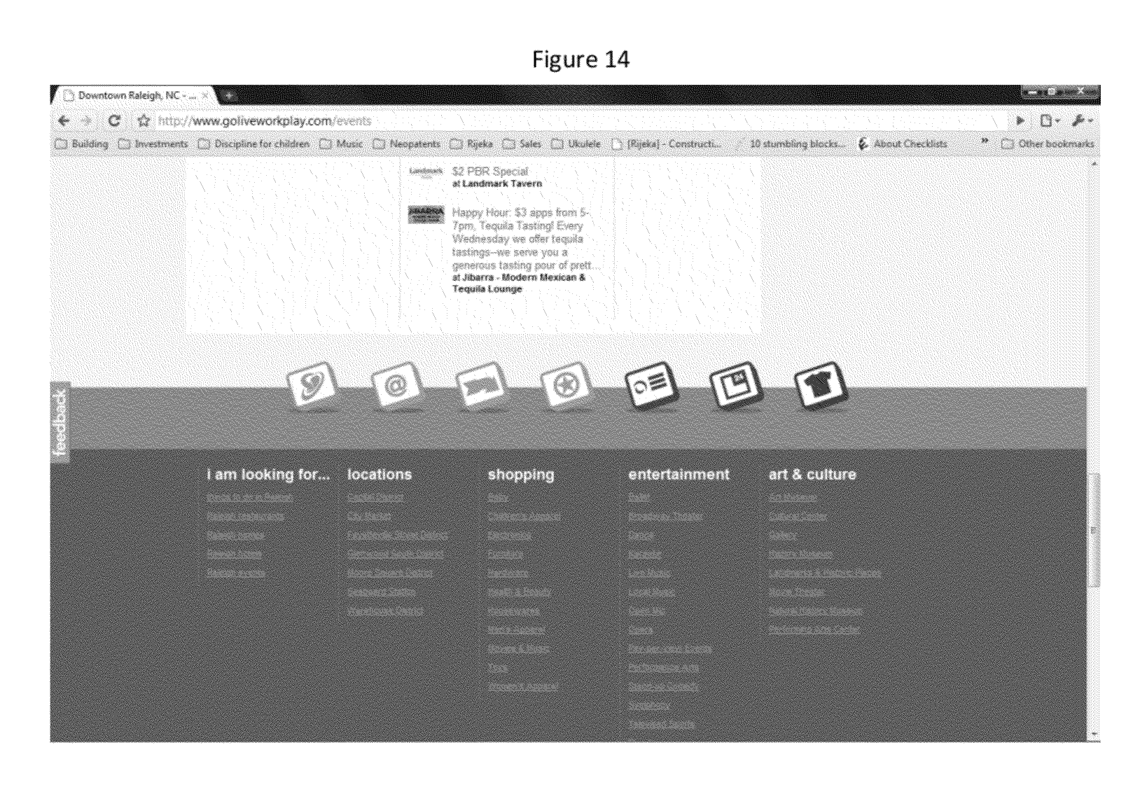

FIGS. 12-14 are screenshots of a website interactive user interface of an embodiment of the present invention, illustrating other aspects of the event page of FIG. 11.

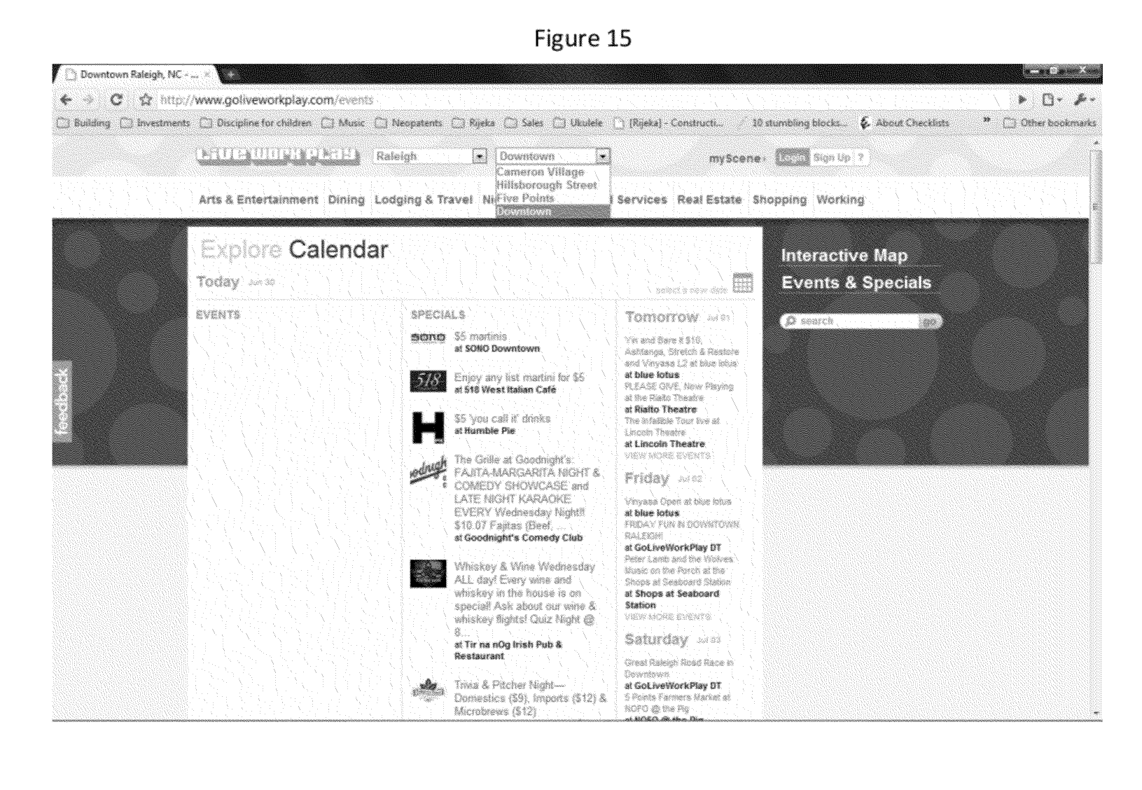

FIG. 15 is a screenshot of a website interactive user interface of one embodiment of the invention, illustrating the events page and drop-down location selection for interactive customer user selection of a location to be included in her/his customized personal settings and/or preferences and/or specific events and locations to schedule and coordinate with other users.

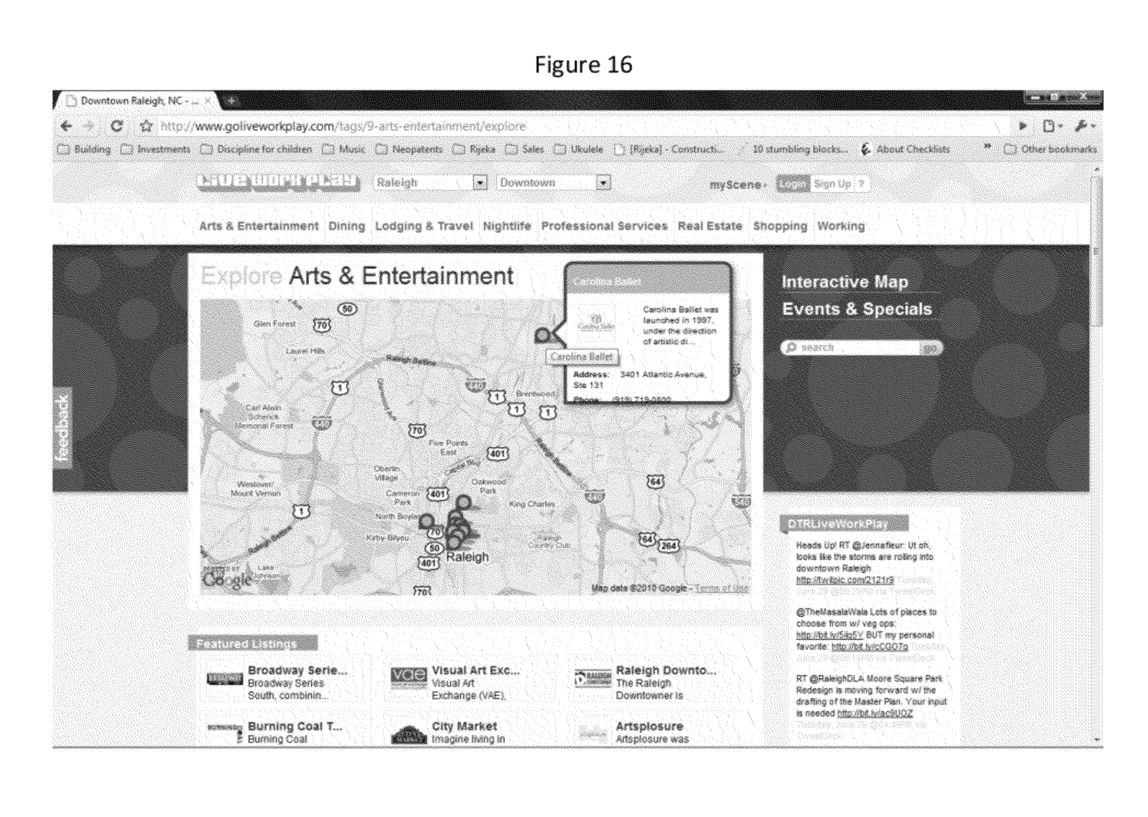

FIG. 16 is a screenshot of a website interactive user interface of one embodiment of the invention, illustrating an explore arts and entertainment page, including at least one pop-up message.

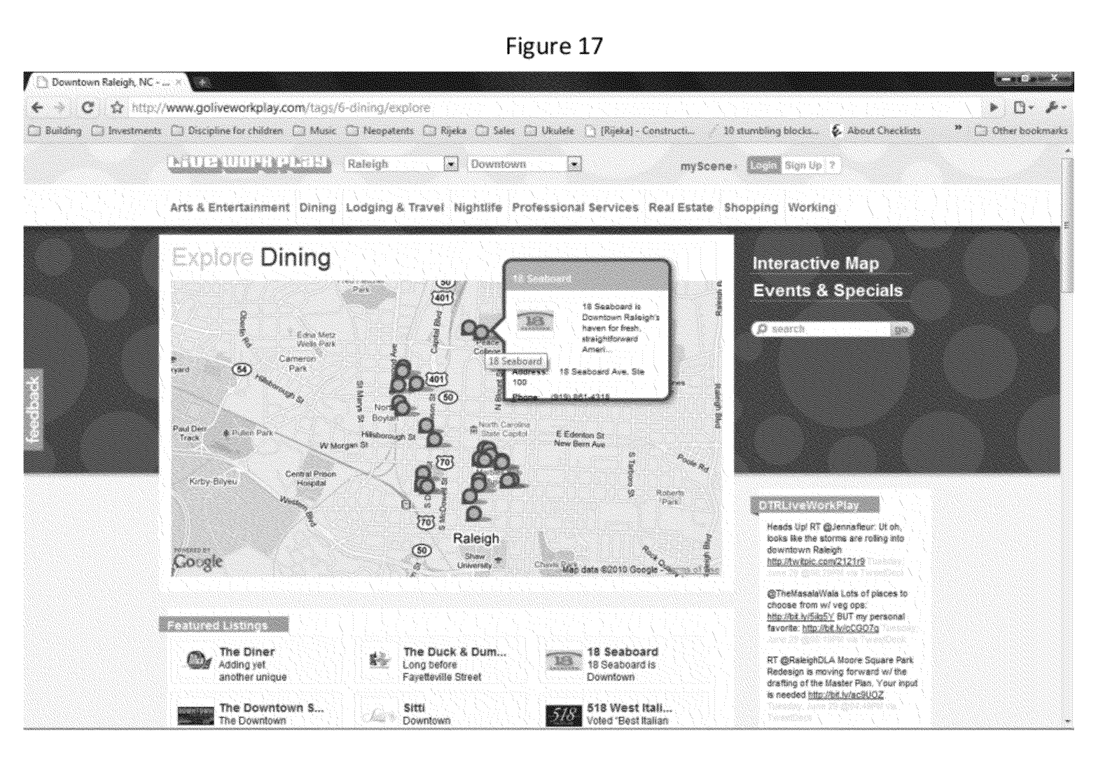

FIG. 17 is a screenshot of a website interactive user interface of one embodiment of the invention, illustrating an explore dining page.

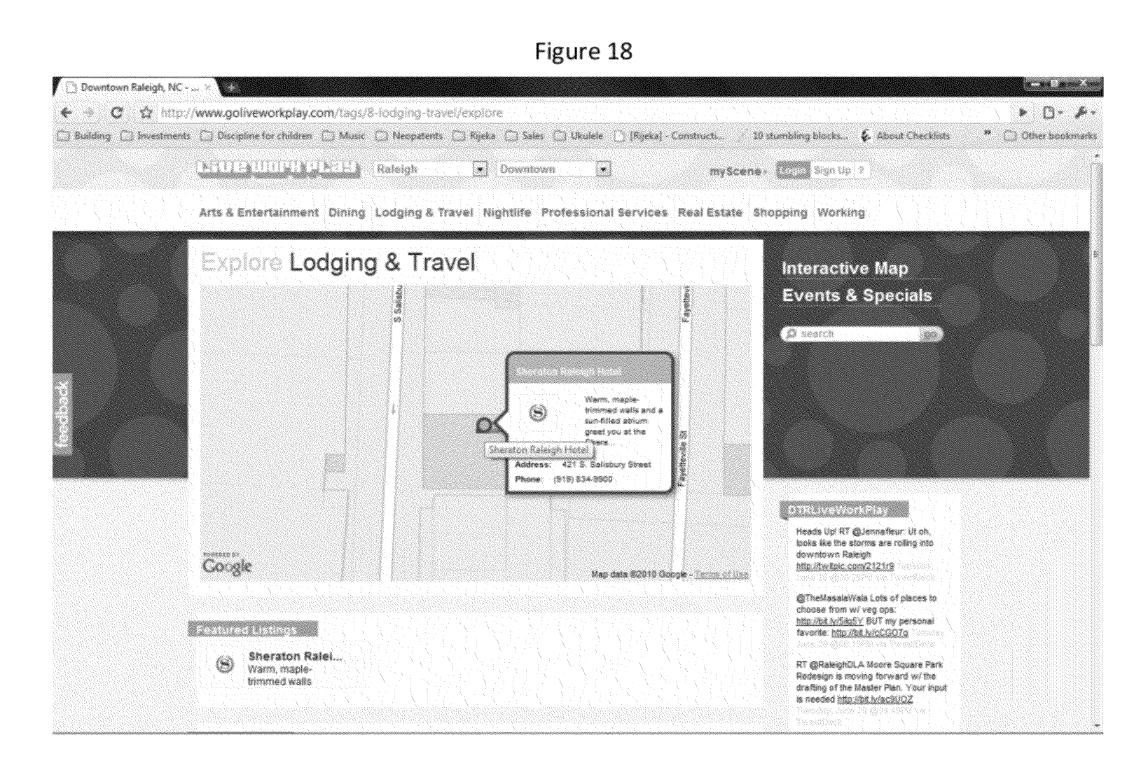

FIG. 18 is a screenshot of a website interactive user interface of one embodiment of the invention, illustrating an explore travel and lodging page.

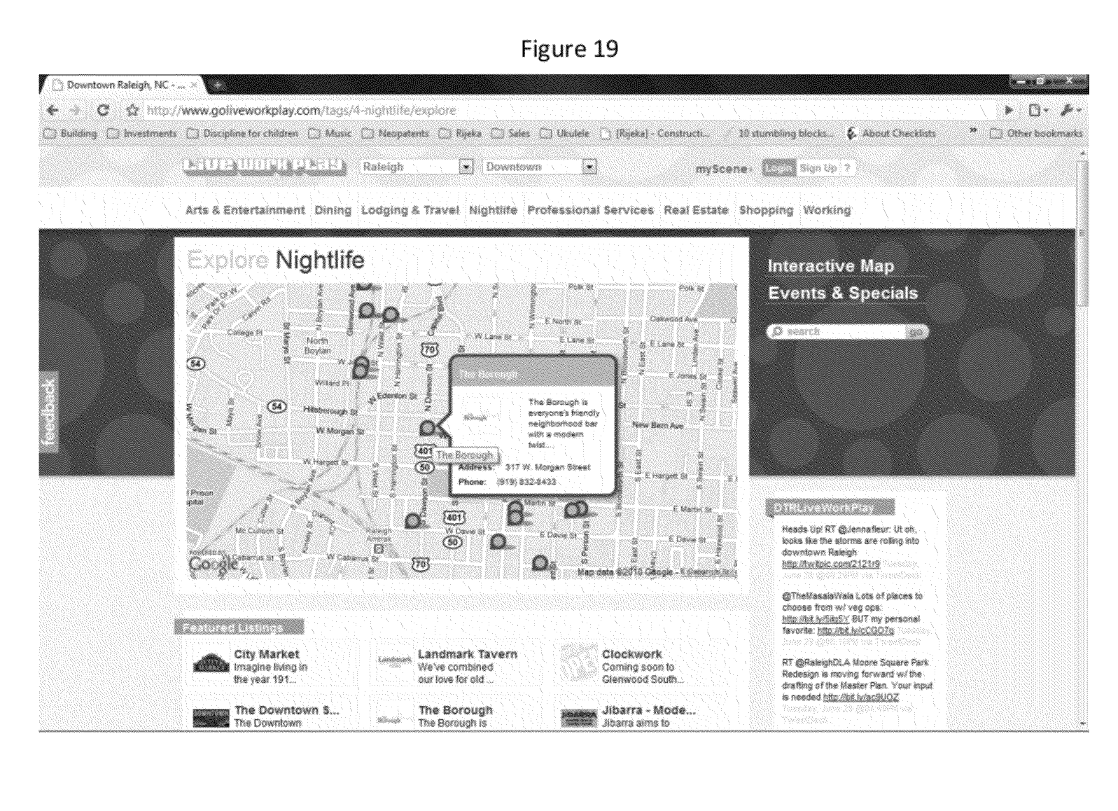

FIG. 19 is a screenshot of a website interactive user interface of one embodiment of the invention, illustrating an explore nightlife page.

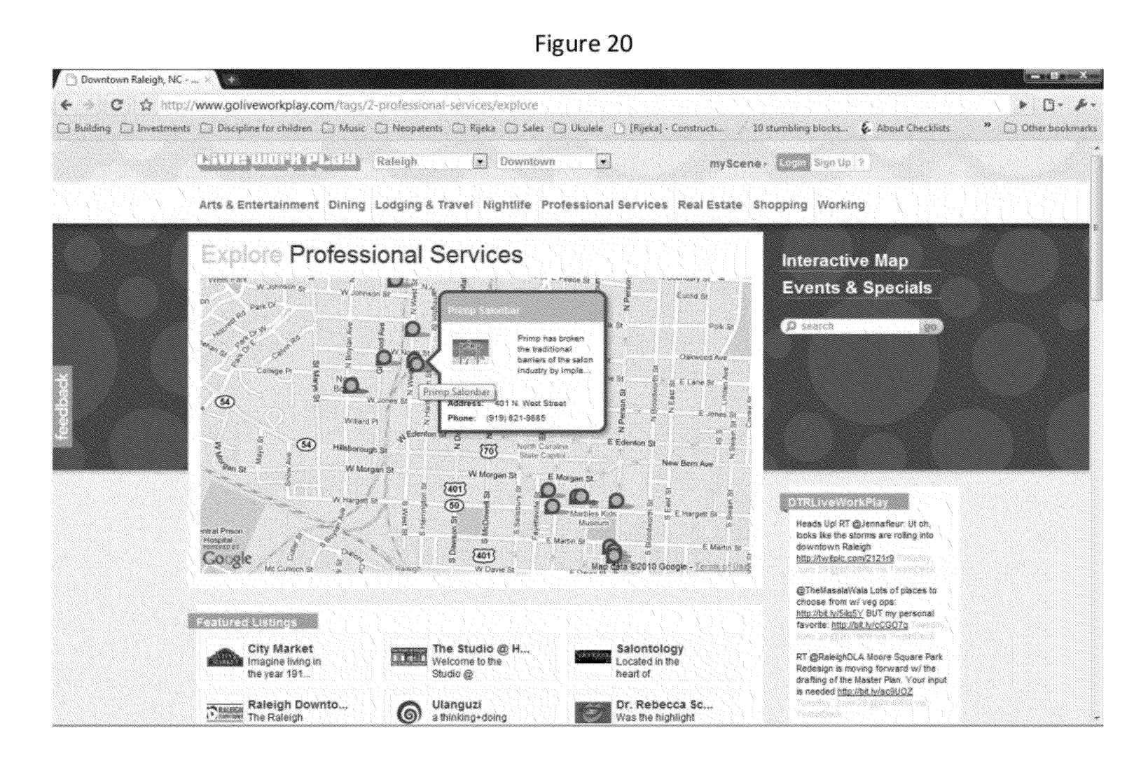

FIG. 20 is a screenshot of a website interactive user interface of one embodiment of the invention, illustrating an explore professional services page.

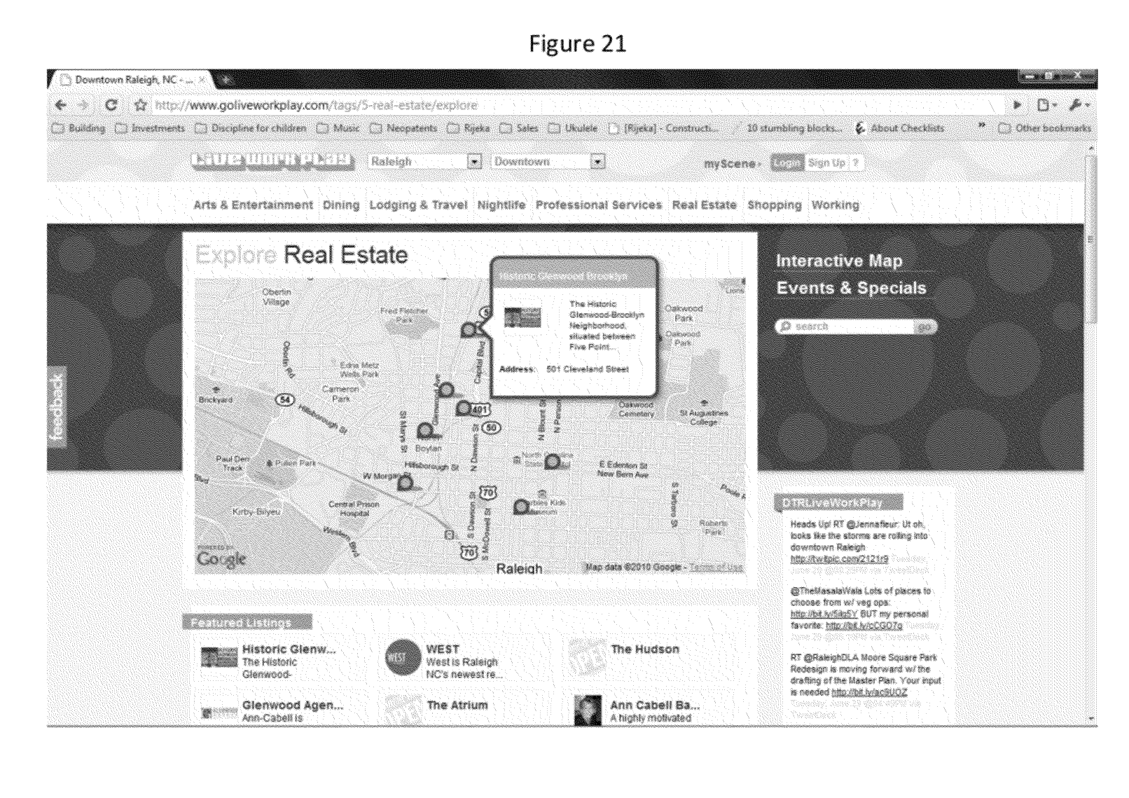

FIG. 21 is a screenshot of a website interactive user interface of one embodiment of the invention, illustrating an explore real estate page.

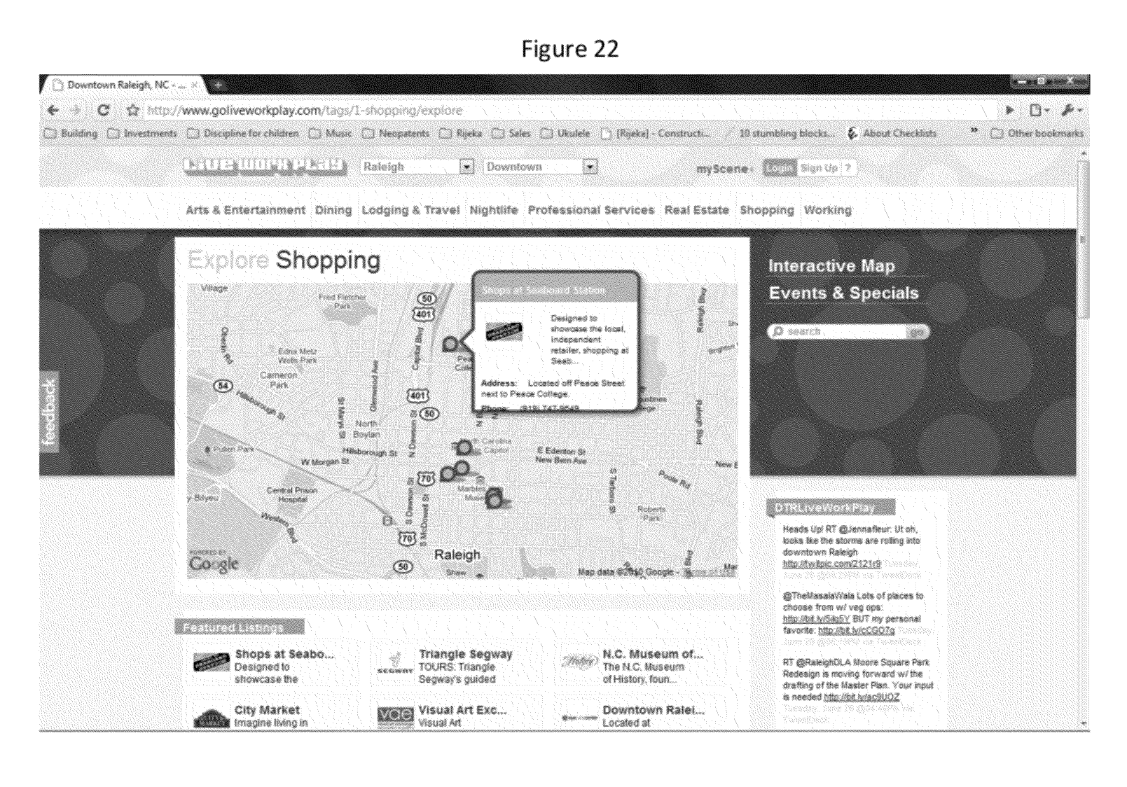

FIG. 22 is a screenshot of a website interactive user interface of one embodiment of the invention, illustrating an explore shopping page.

FIG. 23 is a screenshot of a website interactive user interface of one embodiment of the invention, illustrating an explore working page.

FIG. 24 is a screenshot of a website interactive user interface of one embodiment of the invention, illustrating customer service icons, including pop-up message box.

FIG. 25 is a screenshot of an interactive feedback page.

FIG. 26A is a screenshot of a website interactive user interface of one embodiment of the invention, illustrating an aspect of the present invention, displaying a calendar of local performance events (top half of screenshot).

FIG. 26B is a screenshot of a website interactive user interface of one embodiment of the invention, illustrating another aspect of the present invention, displaying a calendar of local performance events (bottom half of 26A screenshot).

FIG. 27A is a screenshot of a website interactive user interface of one embodiment of the invention, illustrating another aspect of the present invention, featuring an illustrated map of an area, highlighting dining establishments (top half of screenshot).

FIG. 27B is a screenshot of a website interactive user interface of one embodiment of the invention, illustrating another aspect of the present invention, featuring an illustrated map of an area, highlighting dining establishments (bottom half of 27A screenshot).

FIG. 28A is a screenshot of a website interactive user interface of one embodiment of the invention, illustrating another aspect of the present invention, featuring details of a user-selected specific dining location, chosen from the list as shown in FIGS. 27A and 27B (top half of screenshot).

FIG. 28B is a screenshot of a website interactive user interface of one embodiment of the invention, illustrating another aspect of the present invention, featuring a video clip and further details of the user-selected specific dining location, (bottom half of 28A screenshot).

FIG. 29 is a screenshot of a website interactive user interface of one embodiment of the invention, illustrating another aspect of the present invention, wherein a user can chose from a tab and/or drop-down menu of several options for selecting a dining location.

FIG. 30 is a screenshot of a website interactive user interface of one embodiment of the invention, illustrating another aspect of the present invention, showing a user-selected tab option, as described in FIG. 29.

FIG. 31 is a screenshot of a website interactive user interface of one embodiment of the invention, illustrating another aspect of the present invention, showing another user-selected tab option, as described in FIG. 29.

FIG. 32 is a screenshot of a website interactive user interface of one embodiment of the invention, illustrating another aspect of the present invention, showing another user-selected tab option listing an interactive feedback page as described in FIG. 29.

FIG. 33A is a screenshot of a website interactive user interface of one embodiment of the invention, illustrating another aspect of the present invention, showing a calendar of events (top half of screenshot).

FIG. 33B is a screenshot of a website interactive user interface of one embodiment of the invention, illustrating another aspect of the present invention, showing a calendar of events (top half of 33A screenshot).

FIG. 34 is a screenshot of a website interactive user interface of one embodiment of the invention, illustrating another aspect of the present invention, showing an interactive geographic map and featured listings in a specified area.

FIG. 35 is a screenshot of a website interactive user interface of one embodiment of the invention, illustrating another aspect of the present invention, showing a geographic map of a specific, user-selected area.

FIG. 36 is a screenshot of a website interactive user interface of one embodiment of the invention, illustrating a calendar of events listings page.

FIG. 37A is a screenshot of a website interactive user interface of an embodiment of the present invention, highlighting a specific event, description tab details.

FIG. 37B is a screenshot of a website interactive user interface of an embodiment of the present invention, highlighting a location of a specific event, as selected in FIG. 37A, map tab with geographic details.

FIG. 38 is a screenshot of a website interactive user interface of one embodiment of the invention, illustrating the events page and mouse-over location or event selection for interactive customer user.

FIG. 39 is a screenshot of a website interactive user interface of one embodiment of the invention, illustrating a user-selected event calendar with details including locations of events.

FIG. 40 is a screenshot of a website interactive user interface of one embodiment of the invention, illustrating an explore page, highlighting a user-selected shopping location and a location-specific calendar.

FIG. 41 is a screenshot of a website interactive user interface of one embodiment of the invention, illustrating an explore page, highlighting another user-selected location and a location-specific calendar.

FIG. 42 is a screenshot of a website interactive user interface of one embodiment of the invention, illustrating an explore events page, highlighting another user-selected location and a location-specific calendar.

FIG. 43 is a screenshot of a website interactive user interface of one embodiment of the invention, illustrating a welcome message for at least one remote user to access and interact with the systems and methods of the present invention.

FIG. 44 is a screenshot of a website interactive user interface of one embodiment of the invention, illustrating another aspect of the present invention.

FIG. 45 is a screenshot of a website interactive user interface of one embodiment of the invention, illustrating another aspect of the present invention.

FIG. 46 is a screenshot of a website interactive user interface of one embodiment of the invention, illustrating another aspect of the present invention

FIG. 47 is a screenshot of a website interactive user interface of one embodiment of the invention, illustrating another aspect of the present invention, showing a first highlight event.

FIG. 48 is a screenshot of a website interactive user interface of one embodiment of the invention, illustrating another aspect of the present invention, showing a second highlight event.

FIG. 49 is a screenshot of a website interactive user interface of one embodiment of the invention, illustrating another aspect of the present invention, showing a third highlight event.

FIG. 50 is a screenshot of a website interactive user interface of one embodiment of the invention, illustrating another aspect of the present invention, showing an interactive geographic map.

FIG. 51 is a screenshot of a website interactive user interface of one embodiment of the invention, illustrating another aspect of the present invention, showing an explore page including a pop-up message.

FIG. 52 is a screenshot of a website interactive user interface of one embodiment of the invention, illustrating a listings page.

FIG. 53 is a screenshot of a website interactive user interface of one embodiment of the invention, illustrating an events page.

FIGS. 54-56 are screenshots of a website interactive user interface of an embodiment of the present invention, illustrating other aspects of the event page of FIG. 53.

FIG. 57 is a screenshot of a website interactive user interface of one embodiment of the invention, illustrating the events page and drop-down location selection for interactive customer user selection of a location to be included in her/his customized personal settings and/or preferences and/or specific events and locations to schedule and coordinate with other users.

FIG. 58 is a screenshot of a website interactive user interface of one embodiment of the invention, illustrating an explore arts and entertainment page, including at least one pop-up message.

FIG. 59 is a screenshot of a website interactive user interface of one embodiment of the invention, illustrating an explore dining page.

FIG. 60 is a screenshot of a website interactive user interface of one embodiment of the invention, illustrating an explore travel and lodging page.

FIG. 61 is a screenshot of a website interactive user interface of one embodiment of the invention, illustrating an explore nightlife page.

FIG. 62 is a screenshot of a website interactive user interface of one embodiment of the invention, illustrating an explore professional services page.

FIG. 63 is a screenshot of a website interactive user interface of one embodiment of the invention, illustrating an explore real estate page.

FIGS. 64A-64B are screenshots of a website interactive user interface of one embodiment of the invention, illustrating an explore shopping page.

FIG. 65 is a screenshot of a website interactive user interface of one embodiment of the invention, illustrating an explore working page.

FIG. 66 is a screenshot of a website interactive user interface of one embodiment of the invention, illustrating customer service icons, including pop-up message box.

FIG. 67 is an interactive feedback page.

As shown in FIG. 67, the system 200 comprises a server 210 with a processing unit 211. The server 210 is constructed, configured and coupled to enable communication over a network 250. The server provides for user interconnection with the server over the network using a personal computer (PC) 240 positioned remotely from the server. Furthermore, the system is operable for a multiplicity of remote personal computers or terminals 260, 270 to access the server remotely. For example, in a client/server architecture or alternatively, and preferably, a user may interconnect through the network 250 using a user device such as a mobile communication device, such as by way of example and not limitation, a mobile phone, a cell phone, smart phone, laptop computer, netbook, a terminal, personal digital assistant (PDA), or any other computing device suitable for network connection. Also, alternative architectures may be used instead of the client/server architecture. For example, a PC network, or other suitable architecture may be used. In preferred embodiments, the network 250 is the Internet, or it could be an intranet, or any other network suitable for searching, obtaining, and/or using information and/or communications, including receiving the notification and providing a response.

The system of the present invention further includes an operating system 212 installed and running on the server 210, enabling server 210 to communicate through network 250 with the remote, distributed user devices. The operating system may be any operating system known in the art that is suitable for network communication.

A memory 220 is interconnected with the server 210. Memory 220 may be integral with server 210 or may be external to the server and interconnected therewith. A program of instruction 222 is stored on memory 220. According to an exemplary embodiment, the program 222 is computer executable code for using information derived from usage of a communication network to develop a social network for automated notification of calendar openings or appointment availability, or using existing social networks for distribution of the notification, and then the network users or customer users respond through the system for responding affirmatively or negatively to the notification (accept or decline, accept or non-response is decline, etc.). Alternatively, portions of the program for automatic notification of calendar opening or appointment availability 222 may be installed on a user's computing device 240; however, in preferred embodiments, the system is cloud computing based, with the remote client or customer computer devices merely accessing the system and receiving notification via the web or other network.

A remote user (either service provider or customer user) may connect to the server 210 through network 250 from a computing device 240. According to an exemplary embodiment, computing device 240 is a personal computer. Computing device 240 may comprise a bus 242 interconnected to the network 250 such as through a modem, an Ethernet card, or the like. A processing unit 244 may be interconnected with the bus 242. A memory 246 may be interconnected with the processing unit 244 through bus 242. The computing device 240 may also comprise one or more input/output devices 248, such as a mouse, a keyboard, a printer, and the like interconnected to the processing unit 244 through bus 242. A display 249, 269, 279 may be interconnected with the processing unit 244 through bus 242 for providing a graphical user interface on a display, corresponding to a website, preferably interactive GUI and website. The computing device 240 may have a program of instruction 247, such as a driver enabling computing device 240 to interconnect with server 210 through network 250.

When the user enters inputs information into the memory 220, the server 210 creates and updates a profile database 222. The server then executes a matching program 224 against the data stored in memory 220, which includes any data relating to the system for all time or predetermined time. The program 224 detects attributes of the usage, and uses those attributes to build the constraints for receiving notification or acceptance of event notification or invitations from other users (e.g., by a first customer user to at least one second customer user) 224, such as, by way of example but not limitation, for a dinner party at a service provider user, such as a restaurant having a location on the geographic map within the system. The server stores the constraints and other data associated with users and profiles of businesses, service providers, and/or individuals and their corresponding schedule or calendar information 224 in memory 220. As will be described in greater detail below, the event notification or invitation 224 comprises concepts (represented by vertices) and relationships (represented by edges) which relate those concepts to the user.

The profile database 222, informs the event notification or invitation agent 224 to identify concepts of interest to the user, such as, by way of example and not limitation, an invitation to a dinner party by a first customer user to at least one second customer user at a service provider user (restaurant) within the system, also or alternatively, desired goods and/or services, as well as relationships, areas of interest, etc., and to build a network 226, such as a social network, based on those interests. This social network may be temporal, automatically being disbanded upon some completion event, such as the user completing an appointment, or the user responding positively to a prompt to terminate or initiating a termination request to the social network. Alternatively, the social network may remain in effect until proactively terminated by the user. Optionally, other users with common interests may be prompted as to whether or not they wish to join the social network, and added only if they take an acceptance action.

Systems and methods of the present invention provide for virtual computing system-based, web-hosted (“cloud”) site accessible via computer and mobile devices in communication with a network, such as the Internet, wherein a user defines and established his/her personal scene, including relevant geographies and subgeographies (neighborhoods or districts within a city), personal events and activities and/or business-based events or activities, including but not limited to restaurants, for notification, invitation and coordination within the system automatically, for example, within a social network of a customer user and his/her scene, including her/his associated users (such as friends).

The present invention provides automated, user-centric, interactive web-based social networking systems and methods for at least two groups of users, including customer users, which are individuals, and service provider users, which are associated with restaurants, businesses, and/or service provider individuals within predetermined geographies and/or sub-geographies, which combined determine a customized “scene” for each user and associated with a user account and corresponding user profile within the system.

In embodiments of the present invention, the user creates a scene, which includes at least one geography and/or subgeography, at least one location (restaurant, coffee shop, bar, etc.), at least one activity, at least one event, and combinations thereof, and where predetermined by the user for his/her scene, a corresponding notice and/or an invitation for the predetermined or custom-selected additional users that are associated within the social network of the user.

Customer users of the systems and methods of the present invention connect via remote computer connection over a network to a virtualized system (cloud-based computing system having at least one server) through an interactive website. Various screen shot images are provided in the figures to illustrate embodiments of graphic user interfaces that are interactive for the customer users to create at least one account unique to each customer user (a first customer user has at least one first customer user account, . . . n customer user has at least one N user account, etc.). The customer user account relates to at least one geographic location, preferably a city with at least one neighborhood or subgeography. Each neighborhood is modular within the system, i.e., the system is built to include a template format by neighborhood or subgeography module for building a scene associated with the customer user's at least one account. Thus, each module includes a multiplicity of customer users associated with a particular subgeography, such as a neighborhood. The template format provides for service provider users to register in connection with the subgeography and to be connectable with the customer users who are also associated with that same subgeography, based upon their unique corresponding customer user at least one account(s). This template format allows for service provider users to directly automatically advertise through the website module any specials, events, activities, etc. to those customer users who have registered at least one account associated with the target subgeography. Preferably, the service provider members pay a fee to be featured prominently on the virtual neighborhood or subgeography map, wherein the dot or location indicator on the map provides a summary of the service provider and/or a hyperlink directly to another website associated with that service provider member. Therefore, the systems and methods of the present invention provide for automatic information associated with service providers users, including various service providers like restaurants, businesses, vendors, merchants, as companies and/or individuals to be associated with an indicator on a map of a subgeography, wherein the automatic information is provided to customer users who are also associated with the same subgeography within the system, and/or have selected or opted-in to receive information from those service provider users.

Most importantly, the systems and methods of the present invention provide for user-centric social networks, maps, activities, calendaring, and the like for the establishment of the user's “scene” within the system. Prior art systems for maps and events within a geography, such as by way of example, the commercially available service www.citysearch.com, provide a web-based search and events system offered over the internet wherein a user searches by a geography to identify activities, restaurants, events, etc. that are generically presented to any user who searches for that same geography. By contrast to the prior art systems and methods, which actually teach away from the present invention by offering generic information related to a given geography, wherein the user must downselect items and information of preference each time when visiting the site, the present invention provides systems and methods that provide a web-based information system and social network wherein the user creates a customized scene with preferences that are retained by the system, and multiple geographies, events, places, people, and activities, including service providers and invitations, that are saved to the user's profile based upon personal selection (user selected, either manually or based upon registration and activity at participating service provider users) and wherein updates for those personally preselected events, locations, restaurants, service providers, activities, etc. are automatically provided to the user and wherein the user can selectively or automatically notify contacts within his/her personal network or social or business network of those items in predetermined geographies or subgeographies, and also may invite them to events automatically.

Importantly, once the customer user has established her/his scene within the system, s/he can share or link information about her/his events, activities, preferences, and combinations thereof, including invitations or notifications about the same to other customer users who are associated with that customer user through the social network of the system, or other social networks outside the system may optionally be linked or connected via that customer user as well. The customer users may access the interactive website of the virtualized network or “cloud-based” system via remote computers, mobile computing devices, mobile smartphone devices, and the like.

Also importantly, the template of the system provides for customization of any subgeography for any city, e.g., downtownRaleigh.com, northRaleigh.com, . . . anycityneighborhood.com, etc. The virtualized system may also advantageously be related to print advertising and periodicals that are updated based upon the scenes established by service provider users, and distributed in electronic or hard copy format to those customer users who are connected to or associated with the same subgeography or custom scene, thereby providing for accurately targeted advertising to bridge between virtual and hard copy media by service provider users for customer users. The modules are added for each customer user based upon each customer user's inputs to the system, such as selecting new subgeographies and/or service provider users, thereby building a customized, personalized scene for each customer user that includes locations, events, activities, service providers and other connected customer users for automatic connection and information sharing through the system of the present invention, to build a virtual world that mirrors the real life world and connections of customer users.

Other components within the systems and methods of the present invention include traffic alerts, tiers of access based upon account specifics, visitor user access, etc.

Preferably, the systems and methods of the present invention automatically manage notification of special events, special offerings, and openings (such as for reservations or parties) by service provider users to matched customer users within a network (predetermined, opt-in, or opt-out), such as, for example but not limitation, a social network.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A system for social networking and automated events coordination comprising
a. an interactive website accessible from a remote computer device via a network, the website being operable for receiving inputs from at least one remote user through the network from a corresponding remote source, the inputs including identification of at least one event, and corresponding time and location;
b. the website further operable for automatically saving and categorizing the at least one event, and automatically matching the event with social network contacts of the user or other member users associated with the system who are located within a predetermined geographic region of the event location.

2. The system of claim 1, wherein the website further includes information by paid advertisers located within a predetermined geographic region of the event location.

3. A method for social networking and events coordination comprising the steps of:
a. providing an interactive website (site) accessible from a remote computer device via a network;
b. the site receiving inputs from at least one remote user through the network from a corresponding remote source, the inputs including identification of at least one event, and corresponding time and location;
c. the site automatically categorizing and saving the inputs in a database on a server computer associated with the site;
d. the site automatically matching the inputs with social network contacts of the at least one user or other member users associated with the site who are located within a predetermined geographic location of the event location.

4. The method of claim 3, further including the step of the site automatically notifying the social network contacts or other member users identified in the matching step, the notification being sent electronically and including an invitation to the event.

5. The method of claim 3, further including the step of the site accepting replies from the social network contacts or other member users.

6. The method of claim 5, further including the step of the site automatically notifying the event creator user regarding the replies received.

7. The method of claim 3, further including the step of automatically calendaring the event on electronic calendar programs for the social network contacts or other member users.
